(19) United States
(12) Patent Application Publication
(10) Pub. No.: US 2025/0200158 A1
(43) Pub. Date: Jun. 19, 2025

(54) UTILIZATION CONTROL TERMINAL, SYSTEM AND METHOD, UTILIZATION MANAGEMENT SERVER AND METHOD, AND COMPUTER READABLE MEDIUM

(71) Applicant: NEC Corporation, Minato-ku, Tokyo (JP)

(72) Inventor: Yasuji SAITO, Tokyo (JP)

(73) Assignee: NEC Corporation, Minato-ku, Tokyo (JP)

(21) Appl. No.: 18/849,643

(22) PCT Filed: Mar. 29, 2022
(86) PCT No.: PCT/JP2022/015506

§ 371 Date: Sep. 23, 2024

(51) Int. Cl. G06F 21/32

(52) U.S. Cl. CPC G06F 21/32

(57) ABSTRACT

A utilization control terminal includes an acquisition unit configured to acquire, from a storage medium, the user ID and the first biometric information; a saving unit configured to save the user ID and the first biometric information in a storage apparatus; an authentication unit configured to perform biometric authentication based on second biometric information extracted from a captured image of the user and the first biometric information saved in the storing apparatus; a specifying unit configured to specify a user ID associated with the first biometric information that has succeeded in the biometric authentication; a determination unit configured to determine, based on the qualification information associated with the specified user ID, whether or not the user is permitted to use the service; and an output unit configured to output information in accordance with a result of the determination made by the determination unit.

### TECHNICAL FIELD

The present disclosure relates to a utilization control terminal, system, method and program, and a utilization management server, method and program.

### BACKGROUND ART

In accordance with improvement of face authentication techniques, it is now possible to use face authentication to determine whether to allow a user to pass through a security gate. Patent Literature 1 discloses a technique related to an automatic gate system for enabling a user to pass through a gate by face authentication. Patent Literature 2 discloses a technique for enabling a user to pass through an automatic ticket gate by face authentication.

### CITATION LIST

### Patent Literature

[Patent Literature 1] Japanese Unexamined Patent Application Publication No. 2003-331323
[Patent Literature 2] Japanese Unexamined Patent Application Publication No. 2021-060775

### SUMMARY OF INVENTION

### Technical Problem

In order for a predetermined person to receive various kinds of services including being permitted to pass through a gate, the user needs to be appropriately qualified. It is possible to accurately and easily determine that this user is qualified by performing identity verification using biometric authentication. However, use of biometric authentication is not widespread since many users are reluctant to have an external organization hold their biometric information used to perform collation of biometric authentication or tend to be unaware of the benefits of using the biometric authentication.

The present disclosure has been made in view of the aforementioned problem, and an object of the present disclosure is to provide a utilization control terminal, system, method and program, and a utilization management server, method and program for promoting spread of the use of a service that uses biometric authentication.

### Solution to Problem

A utilization control terminal according to the present disclosure includes:
acquiring means for acquiring, from a storage medium that is carried by a predetermined user and stores a user ID and first biometric information of the user, the user ID and the first biometric information by a predetermined mode of short-range radio communication;
saving means for saving the user ID and the first biometric information in a storing apparatus in such a way that they are associated with each other;
authentication means for performing biometric authentication based on second biometric information extracted from a captured image of the user and the first biometric information saved in the storing apparatus;
specifying means for specifying, from the storing apparatus, a user ID associated with the first biometric information that has succeeded in the biometric authentication;
determination means for referring to a database in which the user ID and qualification information on the use of a service by the user are registered in such a way that they are associated with each other to determine, based on the qualification information associated with the specified user ID, whether or not the user is permitted to use the service; and
output means for outputting information in accordance with a result of the determination made by the determination means.

A utilization control system according to the present disclosure includes:
a database in which a user ID of a predetermined user and qualification information on a use of a service by the user are registered in such a way that they are associated with each other; and
a utilization control terminal capable of performing short-range radio communication by one or more modes, in which
the utilization control terminal includes:
   acquiring means for acquiring, from a storage medium that is carried by the user and stores the user ID and first biometric information, the user ID and the first biometric information by a predetermined mode of short-range radio communication;
   saving means for saving the user ID and the first biometric information in a storing apparatus in such a way that they are associated with each other;
   authentication means for performing biometric authentication based on second biometric information extracted from a captured image of the user and the first biometric information saved in the storing apparatus;
   specifying means for specifying, from the storing apparatus, a user ID associated with the first biometric information that has succeeded in the biometric authentication;
   determination means for referring to the database to determine, based on the qualification information associated with the specified user ID, whether or not the user is permitted to use the service; and
   output means for outputting information in accordance with a result of the determination made by the determination means.

A utilization control method according to the present disclosure causes a computer to:
acquire, from a storage medium that is carried by a predetermined user and stores a user ID and first biometric information of the user, the user ID and the first biometric information by a predetermined mode of short-range radio communication;
saving the user ID and the first biometric information in a storing apparatus in such a way that they are associated with each other;
performing biometric authentication based on second biometric information extracted from a captured image of the user and the first biometric information saved in the storing apparatus;
specifying, from the storing apparatus, a user ID associated with the first biometric information that has succeeded in the biometric authentication;
referring to a database in which the user ID and qualification information on the use of a service by the user are registered in such a way that they are associated with each other to determine, based on the qualification information associated with the specified user ID, whether or not the user is permitted to use the service; and
outputting information in accordance with a result of the determination that has been determined.

A utilization control program according to the present disclosure causes a computer to execute:
acquiring processing for acquiring, from a storage medium that is carried by a predetermined user and stores a user ID and first biometric information of the user, the user ID and the first biometric information by a predetermined mode of short-range radio communication;
saving processing for saving the user ID and the first biometric information in a storing apparatus in such a way that they are associated with each other;
authentication processing for performing biometric authentication based on second biometric information extracted from a captured image of the user and the first biometric information saved in the storing apparatus;
specifying processing for specifying, from the storing apparatus, a user ID associated with the first biometric information that has succeeded in the biometric authentication;
determination processing for referring to a database in which the user ID and qualification information on the use of a service by the user are registered in such a way that they are associated with each other to determine, based on the qualification information associated with the specified user ID, whether or not the user is permitted to use the service; and
output processing for outputting information in accordance with a result of the determination made by the determination processing.

A utilization management server according to the present disclosure includes:
calculation means for calculating, when an electronic application for using a predetermined service including a user ID corresponding to first biometric information on a predetermined user is accepted, a usage fee of the service discounted based on attribute information of the user;
registration means for registering, when the user has settled the usage fee, the user ID and qualification information for the use of the service in a database in such a way that they are associated with each other; and
response means for referring to the database when a user ID specified as a result of the user being succeeded in biometric authentication which is based on the first biometric information has been received from a utilization control terminal of the service, and sending a response which is based on the qualification information associated with the received user ID to the utilization control terminal.

A utilization management method according to the present disclosure causes a computer to:
calculate, when an electronic application for using a predetermined service including a user ID corresponding to first biometric information on a predetermined user is accepted, a usage fee of the service discounted based on attribute information of the user;
register, when the user has settled the usage fee, the user ID and qualification information for the use of the service in a database in such a way that they are associated with each other; and
refer to the database when a user ID specified as a result of the user being succeeded in biometric authentication which is based on the first biometric information has been received from a utilization control terminal of the service, and send a response which is based on the qualification information associated with the received user ID to the utilization control terminal.

A utilization management program according to the present disclosure causes a computer to execute:
calculation processing for calculating, when an electronic application for using a predetermined service including a user ID corresponding to first biometric information on a predetermined user is accepted, a usage fee of the service discounted based on attribute information of the user;
registration processing for registering, when the user has settled the usage fee, the user ID and qualification information for the use of the service in a database in such a way that they are associated with each other; and
response processing for referring to the database when a user ID specified as a result of the user being succeeded in biometric authentication which is based on the first biometric information has been received from a utilization control terminal of the service, and sending a response which is based on the qualification information associated with the received user ID to the utilization control terminal.

### Advantageous Effects of Invention

According to the present disclosure, it is possible to provide a utilization control terminal, system, method and program, and a utilization management server, method and program for promoting spread of the use of a service that uses biometric authentication.

### BRIEF DESCRIPTION OF DRAWINGS

FIG. 1 is a block diagram showing a configuration of a utilization control terminal according to a first example embodiment;

FIG. 2 is a flowchart showing a flow of a utilization control method according to the first example embodiment;

FIG. 3 is a block diagram showing a configuration of a utilization management server according to a second example embodiment;

FIG. 4 is a flowchart showing a flow of a utilization management method according to the second example embodiment;

FIG. 5 is a block diagram showing a configuration of a utilization control system according to a third example embodiment;

FIG. 6 is a block diagram showing a configuration of a non-contact type IC card according to the third example embodiment;

FIG. 7 is a block diagram showing a configuration of a user terminal according to the third example embodiment;

FIG. 8 is a block diagram showing a configuration of a utilization management server according to the third example embodiment;

FIG. 9 is a block diagram showing a configuration of an edge terminal according to the third example embodiment;

FIG. 10 is a sequence diagram showing a flow of face information registration processing according to the third example embodiment;

FIG. 11 is a diagram showing an example of screen transition of face information registration processing in a user terminal according to the third example embodiment;

FIG. 12 is a sequence diagram showing a flow of electronic application processing according to the third example embodiment;

FIG. 13 is a diagram showing an example of screen transition of ticket purchase processing in the user terminal according to the third example embodiment;

FIG. 14 is a diagram for describing a concept of entry processing using a user terminal according to Example 3-1 of the third example embodiment;

FIG. 15 is a sequence diagram showing a flow of entry processing using the user terminal according to Example 3-1 of the third example embodiment;

FIG. 16 is a diagram showing an example of screen transition of entry processing in the user terminal according to Example 3-1 of the third example embodiment;

FIG. 17 is a diagram for describing a concept of entry processing using a non-contact type IC card according to Example 3-2 of the third example embodiment;

FIG. 18 is a sequence diagram showing a flow of entry processing using the non-contact type IC card according to Example 3-2 of the third example embodiment;

FIG. 19 is a diagram showing a display example of guidance information of a mode of short-range radio communication in an edge terminal according to the third example embodiment;

FIG. 20 is a diagram showing a display example of the modes of the short-range radio communication that respective edge terminals can support according to the third example embodiment;

FIG. 21 is a diagram for describing a concept of reserved seat ticket check processing performed by a conductor according to a fourth example embodiment;

FIG. 22 is a sequence diagram showing a flow of reserved seat ticket check processing performed by the conductor according to the fourth example embodiment; and

FIG. 23 is a diagram showing an example of screen transition of processing for writing feature information into a non-contact type IC card according to a fifth example embodiment.

### EXAMPLE EMBODIMENT

Hereinafter, with reference to the drawings, example embodiments of the present disclosure will be described in detail. Throughout the drawings, the same or corresponding elements are denoted by the same reference symbols, and redundant descriptions will be omitted as appropriate for the sake of clarification of the description.

### First Example Embodiment

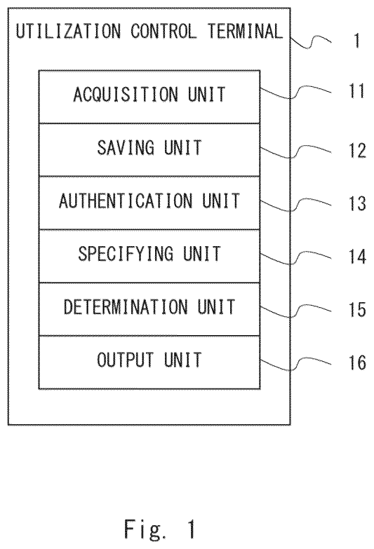

FIG. 1 is a block diagram showing a configuration of a utilization control terminal 1 according to a first example embodiment. The utilization control terminal 1 is an information processing apparatus for determining, by using biometric authentication, that a predetermined user is qualified to use a predetermined service and perform, when it is determined that the user is qualified to use the predetermined service, control in accordance with the service. The use of the predetermined service may include, for example, entering a facility or a floor with restricted entry, receiving a paid service such as watching a movie, or the like. The predetermined service may instead be a free service.

It is assumed that a predetermined user carries a storage medium. The storage medium stores a user ID and first biometric information of the user. The storage medium may be, for example, a storing apparatus embedded in a portable information terminal such as a smartphone, a tablet terminal, or the like. Alternatively, the storage medium may be embedded in a non-contact type Integrated Circuit (IC) card. The information terminal and the non-contact type IC card are configured to be able to perform communication by a predetermined mode of short-range radio communication and to transmit the user ID and the first biometric information stored in the storage medium by the above mode. Note that the information terminal and the non-contact type IC card may support two or more modes of the short-range radio communication. Further, the first biometric information is associated with the user ID in the storage medium. The “biometric information” is data including a plurality of feature points extracted from a captured image of at least a part of a user's body and distances between the respective feature points.

The utilization control terminal 1 includes an acquisition unit 11, a saving unit 12, an authentication unit 13, a specifying unit 14, a determination unit 15, and an output unit 16. The acquisition unit 11 acquires the user ID and the first biometric information from the storage medium carried by the predetermined user by the predetermined mode of short-range radio communication.

The saving unit 12 saves the user ID and the first biometric information acquired by the acquisition unit 11 in the storing apparatus in such a way that they are associated with each other. The storing apparatus may be either the one included in the utilization control terminal 1 or an external storing apparatus connected to the utilization control terminal 1.

The authentication unit 13 performs biometric authentication based on second biometric information extracted from a captured image of the user and the above first biometric information saved in the storing apparatus. Specifically, the authentication unit 13 collates the second biometric information with the first biometric information to calculate a degree of match, and determines that the biometric authentication has succeeded when the degree of match is equal to or larger than a threshold.

The specifying unit 14 specifies, from the above storing apparatus, the user ID associated with the first biometric information that has succeeded in the biometric authentication performed by the authentication unit 13.

The determination unit 15 determines whether or not the user is permitted to use the service based on qualification information on the use of the service by the user. The qualification information is information indicating whether or not the user is qualified to use the service, information for certifying that the user has settled the usage fee of a paid service, or the like. Therefore, the qualification information may be, for example, ticket information of the paid service. It is assumed here that the utilization control terminal 1 is connected to a database. User IDs and pieces of qualification information on the use of services by respective users are registered in the database in advance in such a way that they are associated with each other. Then, the utilization control terminal 1 refers to the database and determines, based on the qualification information associated with the user ID specified by the specifying unit 14, whether or not the user is permitted to use the service. When, for example, qualification information associated with the user ID is registered in the above database, the determination unit 15 may determine that the user can be permitted to use the service. Alternatively, when the qualification information associated with the user ID meets predetermined conditions, the determination unit 15 may determine that the user can be permitted to use the service. Further, the database may be managed in a predetermined server. Then, the determination unit 15 may transmit the user ID to the server to send an inquiry to the server about whether or not the user is permitted to use the service. In this case, this server may refer to the database, search for the qualification information associated with the received user ID, and determine whether or not the user can be permitted to use the service depending on whether or not the qualification information has been searched or whether or not the qualification information satisfies predetermined conditions. In this case, this server may send a result of the determination back to the utilization control terminal 1. Then the determination unit 15 determines whether or not the user is permitted to use the service depending on the received result of the determination.

The output unit 16 outputs information in accordance with the result of the determination made by the determination unit 15. The output unit 16 may output, for example, the result of the determination itself. Further, the output unit 16 may output a control signal of another device in accordance with the result of the determination. Further, the output unit 16 may output information in accordance with the result of the determination to a user terminal or a terminal of an administrator.

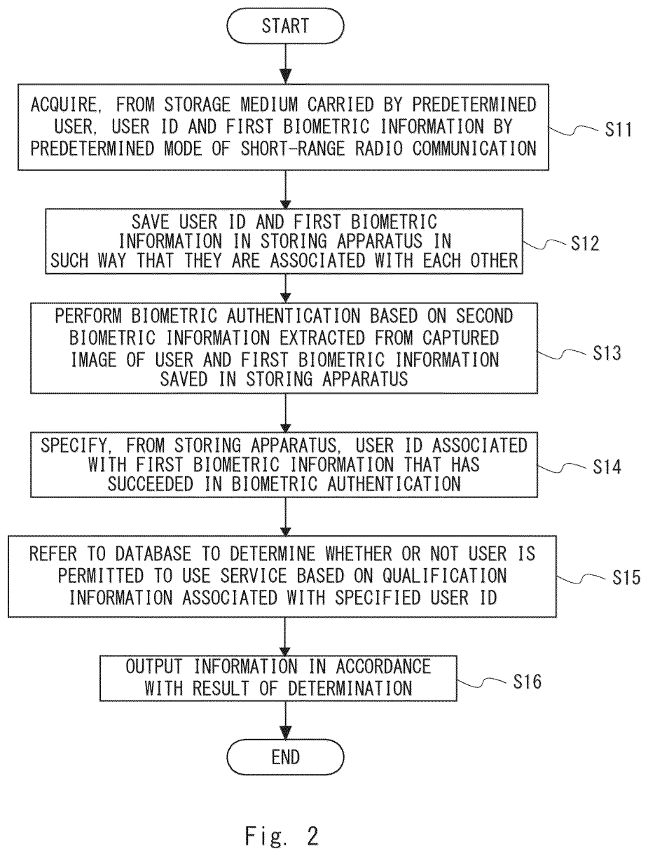

FIG. 2 is a flowchart showing a flow of a utilization control method according to the first example embodiment. First, the acquisition unit 11 acquires, from a storage medium carried by a predetermined user, a user ID and first biometric information by a predetermined mode of short-range radio communication (S11). That is, the user who carries the storage medium enters a range of short-range radio communication of a predetermined mode of the utilization control terminal 1, whereby data in the storage medium is forwarded to the utilization control terminal 1 by the predetermined mode.

Next, the saving unit 12 saves the user ID and the first biometric information in the storing apparatus in such a way that they are associated with each other (S12). Then, an image of an area including a face of a user who is within the short-range radio communication of the predetermined mode is captured by a camera embedded in the utilization control terminal 1 or a camera connected to the utilization control terminal 1. The authentication unit 13 performs biometric authentication based on second biometric information extracted from the captured image of the user and the first biometric information saved in the storing apparatus (S13).

It is assumed here that the biometric authentication has succeeded. The specifying unit 14 then specifies, from the storing apparatus, a user ID associated with the first biometric information that has succeeded in the biometric authentication (S14). Then the determination unit 15 refers to the above database to determine whether or not the user is permitted to use the service based on the qualification information associated with the user ID specified in Step S14 (S15). Then the output unit 16 outputs the information in accordance with the result of the determination in Step S15 (S16).

As described above, in this example embodiment, at least a user ID and biometric information himself/herself are held by the user, and a user ID and qualification information are saved in a database on the side of the service provider in advance. That is, the biometric information and the qualification information are managed separately from each other, whereby there is no need to provide biometric information to the service provider. Then, a set of the user ID and the biometric information are forwarded from the storage medium carried by the user to the utilization control terminal 1 by short-range radio communication at a timing when the user uses the service, and the utilization control terminal 1 saves the set of the user ID and the biometric information in the storing apparatus at least temporarily. Then, the utilization control terminal 1 captures a face image of the user at the same timing. The utilization control terminal 1 is able to perform biometric authentication based on the first biometric information saved in the storing apparatus and the second biometric information extracted from the face image. When the biometric authentication has succeeded, it is possible to specify qualification information associated with the user ID from the database on the side of the service provider and determine whether or not the user is permitted to use the service. From the above discussion, it is possible to secure the safety of storing the biometric information and eliminate concerns that an external organization holds biometric information used to collate biometric authentication. It is therefore possible to promote spread of the use of the service that uses biometric authentication.

Note that the utilization control terminal 1 includes, as components that are not shown, a processor, a memory, and a storing apparatus. Further, this storing apparatus stores a computer program in which processing of the utilization control method according to this example embodiment is implemented. This processor loads a computer program or the like into the memory from the storing apparatus to execute the computer program. Accordingly, the processor implements functions of the acquisition unit 11, the saving unit 12, the authentication unit 13, the specifying unit 14, the determination unit 15, and the output unit 16.

Alternatively, each of the components of the utilization control terminal 1 may be implemented by special-purpose hardware. Further, some or all of the components of each apparatus may each be implemented by a general-purpose or special-purpose circuitry, processor, or a combination of them. They may be configured using a single chip, or a plurality of chips connected through a bus. Some or all of the components of each apparatus may be implemented by a combination of the above-described circuitry, etc. and a program. Further, a Central Processing Unit (CPU), a Graphics Processing Unit (GPU), a Field-Programmable Gate Array (FPGA), a quantum processor (quantum computer control chip) and so on may be used as the processor.

### Second Example Embodiment

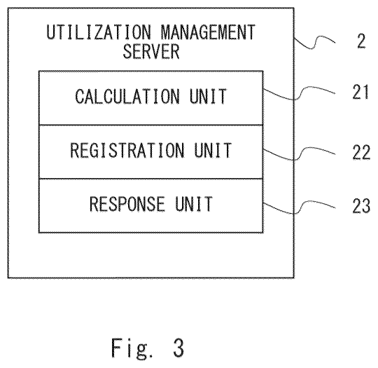

FIG. 3 is a block diagram showing a configuration of a utilization management server 2 according to the second example embodiment. The utilization management server 2 is an information processing apparatus that calculates a usage fee when a predetermined user uses a predetermined service in accordance with attribute information on the predetermined user, registers qualification information on this user in a database, and sends a response by referring to the database when the user requests to use the service. The attribute information includes the age (date of birth), sex, identification information, and the like of the user. The identification information includes, for example, certificate information of a level of disability or a level of care given by an official organization, information corresponding to a student identification card, or the like. Further, the database is similar to one described above in the first example embodiment, and user IDs and pieces of qualification information on the use of services by the respective users are registered in the database in advance in such a way that they are associated with each other. It is assumed that the utilization management server 2 includes this database therein or is connected to an external database server or storage apparatus that includes manages this database.

The utilization management server 2 includes a calculation unit 21, a registration unit 22, and a response unit 23. The calculation unit 21 calculates, when it has accepted an electronic application for using a predetermined service including a user ID corresponding to first biometric information on a predetermined user, a usage fee of the service discounted based on the attribute information of the user. For example, the calculation unit 21 calculates, when the attribute information indicates an elderly person, a person with disabilities, a student, or the like, a usage fee taking into account the discount in accordance with each attribute.

The registration unit 22 registers, when the user has settled the usage fee, the user ID and the qualification information on the use of the service in the database in such a way that they are associated with each other.

When the response unit 23 has received the user ID from a utilization control terminal of the service, the response unit 23 refers to a database and sends a response which is based on the qualification information associated with the received user ID to the utilization control terminal. The utilization control terminal may be, for example, the utilization control terminal 1 according to the above-described first example embodiment. Further, the user ID received by the response unit 23 has been specified as a result of the user being succeeded in the biometric authentication based on the first biometric information in the utilization control terminal. Note that the response unit 23 may transmit the result of the determination indicating whether or not the user is permitted to use the service to the utilization control terminal as a response which is based on the qualification information. Alternatively, the response unit 23 may read out the qualification information associated with the user ID received from the database and send the qualification information that has been read out to the utilization control terminal as a response.

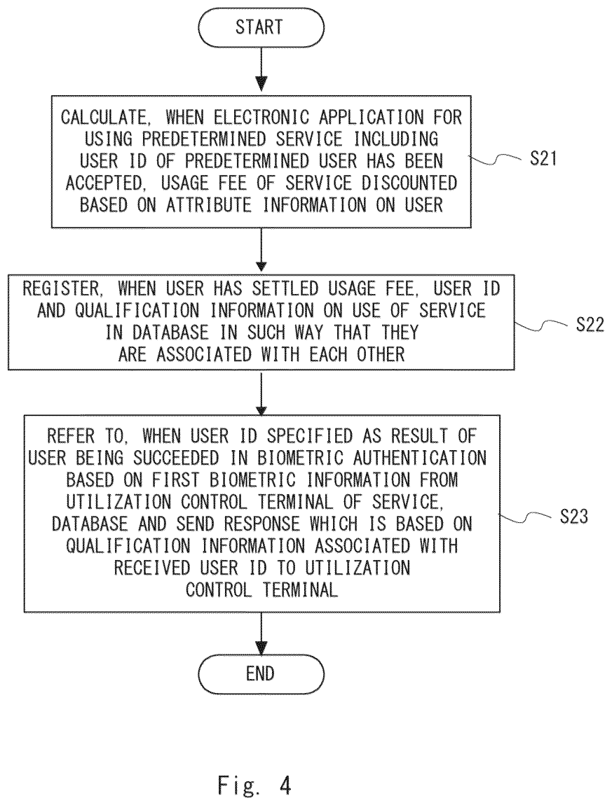

FIG. 4 is a flowchart showing a flow of a utilization management method according to the second example embodiment. First, the calculation unit 21 calculates, when an electronic application for using a predetermined service including a user ID corresponding to the first biometric information on a predetermined user has been accepted, the usage fee of the service discounted based on the attribute information on this user (S21).

Next, the registration unit 22 registers, when the user has settled the usage fee, the user ID and the qualification information on the use of the service in the database in such a way that they are associated with each other (S22).

After that, the response unit 23 receives, from the utilization control terminal, the user ID specified as a result of the user being succeeded in the biometric authentication based on the first biometric information. Then, when the response unit 23 has received the above user ID from the utilization control terminal of the service, the response unit 23 refers to the database and sends a response which is based on the qualification information associated with the received user ID to the utilization control terminal (S23).

As described above, in this example embodiment, a user can receive a discount on the usage fee based on attribute information when he/she makes an electronic application, which makes it possible to let the user know more about the benefits of using the biometric authentication and thus promote spread of the use of the service that uses the biometric authentication.

Note that the utilization management server 2 includes, as components that are not shown, a processor, a memory, and a storing apparatus. Further, this storing apparatus stores a computer program in which processing of a utilization management method according to this example embodiment is implemented. Then the processor loads a computer program or the like into the memory from the storing apparatus to execute this computer program. Accordingly, the processor implements functions of the calculation unit 21, the registration unit 22, and the response unit 23.

Alternatively, each of the components of the utilization management server 2 may be implemented by special-purpose hardware. Further, some or all of the components of each apparatus may each be implemented by a general-purpose or special-purpose circuitry, processor, or a combination of them. They may be configured using a single chip, or a plurality of chips connected through a bus. Some or all of the components of each apparatus may be implemented by a combination of the above-described circuitry, etc. and a program. Further, a Central Processing Unit (CPU), a Graphics Processing Unit (GPU), a Field-Programmable Gate Array (FPGA), a quantum processor (quantum computer control chip) and so on may be used as the processor.

Further, when some or all of the components of the utilization management server 2 are implemented by a plurality of information processing apparatuses, circuits, or the like, the plurality of information processing apparatuses, the circuits, or the like may be disposed in one place in a centralized manner or arranged in a distributed manner. For example, the information processing apparatuses, the circuits, and the like may be implemented as a form such as a client-server system, a cloud computing system or the like in which they are connected to each other through a communication network. Further, the functions of the utilization management server 2 may be provided in the form of Software as a Service (Saas).

### Third Example Embodiment

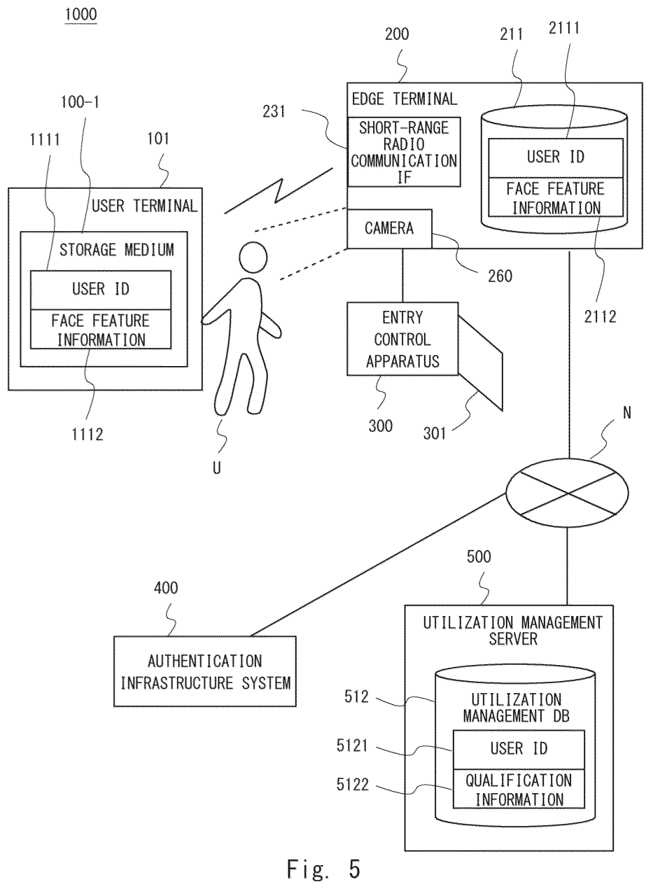

A third example embodiment is a specific example of the above-described first and second example embodiments. FIG. 5 is a block diagram showing a configuration of a utilization control system 1000 according to the third example embodiment. The utilization control system 1000 is an information system for enabling a user U who has purchased a movie ticket via a website in advance to pass through an entrance gate in a movie theater by face authentication and qualification information. Note that the entry to the movie theater and movie viewing after entering the movie theater are examples of use of a predetermined service. Other use of the service may include, for example, but not limited to, check-in at an airport, luggage check-in, passage through a boarding gate, use of transportation such as a train, a bus, a ship, or the like, and use of various kinds of services with preferential fee.

The user U carries a user terminal 101. The user terminal 101, which includes a storage medium 100-1 therein, can perform communication by one or more modes of short-range radio communication. The storage medium 100-1 stores a user ID 1111 and face feature information 1112. The detailed configurations of the user terminal 101 will be described later.

In the utilization control system 1000, the edge terminal 200, the authentication infrastructure system 400, and the utilization management server 500 are each connected to one another via a network N in such a way that they can communicate with one another. The entry control apparatus 300 may also be connected via the network N in such a way that they can communicate with one another. The network N, which is a wired or wireless communication line or communication network, is, for example, Local Area Network (LAN), the internet, a wireless communication network, a mobile telephone network or the like. Further, the communication protocol of the network N can be of any type.

The edge terminal 200 is one example of the above-described utilization control terminal 1. The edge terminal 200 acquires the user ID 1111 and the face feature information 1112 from the user terminal 101 via a short-range radio communication Interface (IF) 231 by a predetermined mode of short-range radio communication. Note that the edge terminal 200 may acquire the user ID 1111 and the face feature information 1112 from a non-contact type IC card 102 that will be described later. The edge terminal 200 saves a user ID 2111 and face feature information 2112 that have been acquired in a storing apparatus included in the edge terminal 200 as user information 211 in such a way that they are associated with each other. Further, the edge terminal 200 captures an image of the user U by a camera 260, and collates face feature information extracted from the face image with the face feature information 2112 to perform face authentication. When the face authentication has succeeded, the edge terminal 200 transmits the user ID 2111 to the utilization management server 500 via the network N, determines whether or not the user is qualified to enter the movie theater, and controls the entry control apparatus 300 in accordance with the result of the determination. When, for example, the result of the determination indicates that the user U is qualified to enter the movie theater (the user U is permitted to use the movie theater, the user U can view a movie, etc.), the edge terminal 200 controls the entry control apparatus 300 to open a gate 301. Note that the detailed configuration of the edge terminal 200 will be described later.

The entry control apparatus 300 is an apparatus for controlling opening, closing, and the like of the gate 301, which is an entrance to the movie theater, in accordance with an instruction sent from the edge terminal 200. Note that the gate 301 is not limited to a flapper gate.

The authentication infrastructure system 400 is an information system that extracts face feature information from the face image of the user U and issues a user ID corresponding to the face feature information. Note that the authentication infrastructure system 400 may include a database in which the face feature information and the user ID are associated with each other.

The utilization management server 500 is one example of the above-described utilization management server 2. The utilization management server 500 is an information processing apparatus that includes a utilization management DB 512 in which a user ID 5121 and qualification information 5122 of the user U are associated with each other. Note that the utilization management DB 512 may instead be managed outside the utilization management server 500, that is, in a database server or a storage apparatus connected to the utilization management server 500.

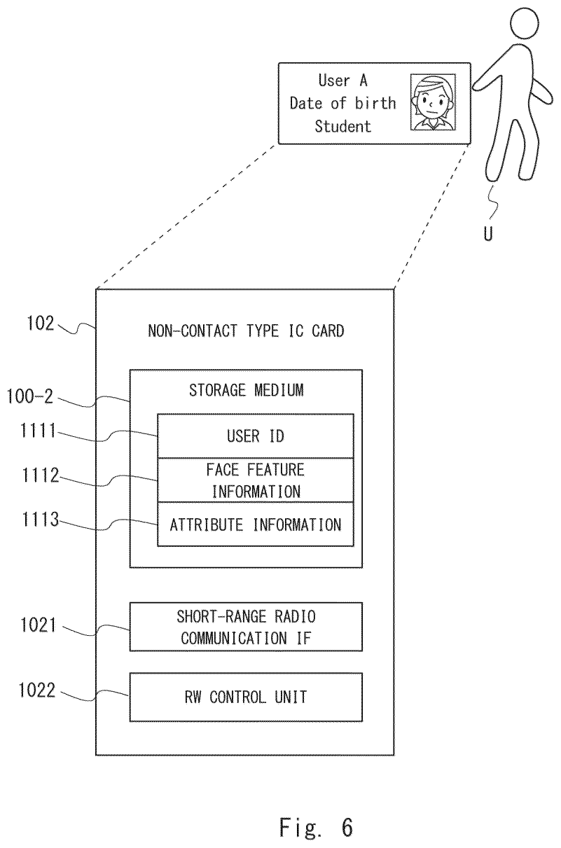

FIG. 6 is a block diagram showing a configuration of the non-contact type IC card 102 according to the third example embodiment. The non-contact type IC card 102 corresponds to a digital ID of the user U. The non-contact type IC card 102 includes a storage medium 100-2, a short-range radio communication IF 1021, a Reader-Writer (RW) control unit 1022, and so on. The non-contact type IC card 102 includes a so-called IC chip therein, including the storage medium 100-2, the short-range radio communication IF 1021, and the RW control unit 1022. The non-contact type IC card 102 may be regarded as an IC tag capable of performing communication by a predetermined mode of the short-range radio communication. In the storage medium 100-2, a user ID 1111, face feature information 1112, and attribute information 1113 are recorded in such a way that they are associated with one another. The user ID 1111, which is identification information on the user U, may be the same as an ID (My Number Card or the like) in a digital ID. The user ID 1111 may instead be different from the ID in the digital ID. It is assumed that the user ID 1111 is associated with at least the face feature information 1112 and is the same as or uniquely corresponds to the user ID 5121 managed in the utilization management DB 512. The face feature information 1112 is data including a plurality of feature points extracted from the face image of the user U by the authentication infrastructure system 400 and distances between the respective feature points, or features calculated from the face image. In the following description, the above-described storage medium 100-1 and the storage medium 100-2 may be collectively referred to as a “storage medium 100”.

The short-range radio communication IF 1021 establishes connection with and communicates with, by the mode Y of the short-range radio communication, an IF of another apparatus of the same mode which is within a predetermined area. The short-range radio communication IF 1021 may be implemented in an antenna, an interface circuit, or the like. The mode Y may correspond to, for example, but not limited to, a standard or a mode such as Near Field Communication (NFC) or Radio Frequency IDentification (RFID).

The RW control unit 1022 performs radio communication with a reader/writer device capable of performing short-range radio communication with the IC tag, which is the non-contact type IC card 102, by the mode Y. Specifically, the RW control unit 1022 performs, when the non-contact type IC card 102 is within a communication range of the reader/writer of the mode Y of the edge terminal 200, communication with the edge terminal 200 via the short-range radio communication IF 1021 by the mode Y. That is, the RW control unit 1022 reads out the user ID 1111 and the face feature information 1112 from the storage medium 100-2 and transmits the user ID 1111 and the face feature information 1112 to the edge terminal 200 via the short-range radio communication IF 1021.

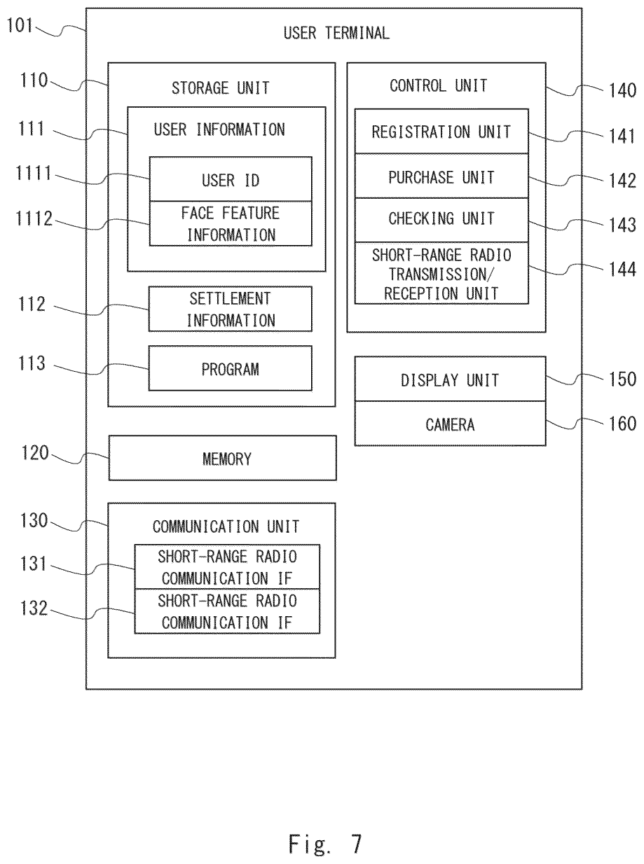

FIG. 7 is a block diagram showing a configuration of the user terminal 101 according to the third example embodiment. The user terminal 101 is a mobile-type information processing apparatus such as a tablet terminal or a smartphone. The user terminal 101 includes a storage unit 110, a memory 120, a communication unit 130, a control unit 140, a display unit 150, and a camera 160. The storage unit 110, which includes the above-described storage medium 100-1. is one example of a storing apparatus such as a flash memory. The storage unit 110 stores user information 111, settlement information 112, and a program 113. The user information 111 is information in which a user ID 1111 and face feature information 1112 of the user U are associated with each other. The settlement information 112 is information for enabling the user U to perform electronic settlement. The settlement information 112 is, for example, a bank account, credit card information, or the like. Note that the settlement information 112 is not necessarily stored in the storage unit 110. The program 113 is a computer program in which face information registration processing, electronic application processing (ticket purchase processing), processing for displaying various kinds of information, etc. according to the second example embodiment are implemented.

The memory 120, which is a volatile storing apparatus such as a Random Access Memory (RAM), is a storing area for temporarily holding information when the control unit 140 is operated. The communication unit 130 is a radio communication interface with the network N. The communication unit 130 may be connected to the internet via a radio communication network or a mobile telephone network. Further, the communication unit 130 can perform radio communication by a plurality of modes of short-range radio communication. Specifically, the communication unit 130 includes short-range radio communication IFs 131 and 132. The short-range radio communication IF 131 establishes connection with and communicates with, by the mode X of the short-range radio communication, an IF of another apparatus of the same mode which is within a predetermined area. The mode X may correspond to, for example, but not limited to, a standard or a mode such as Bluetooth (registered trademark) or Bluetooth Low Energy (BLE). The short-range radio communication IF 132 establishes connection with and communicates with, by the mode Y of the short-range radio communication, an IF of another apparatus of the same mode which is within a predetermined area. The mode Y is a mode the same as the above-described short-range radio communication IF 1021.

The display unit 150 is a screen such as a liquid crystal display or an Organic Electro-Luminescence (EL) display. The display unit 150 displays information instructed from the control unit 140. The camera 160 is one or more image-capturing apparatuses, captures an image of the face of the like of the user U in accordance with the operation by the user U or an instruction sent from the control unit 140, outputs the captured image to the control unit 140, and causes the image to be displayed on the display unit 150.

The control unit 140 is a processor that controls each component of the user terminal 101, that is, a control apparatus. The control unit 140 loads the program 113 into the memory 120 from the storage unit 110 to execute the program 113. Accordingly, the control unit 140 implements functions of a registration unit 141, a purchase unit 142, a checking unit 143, and a short-range radio transmission/reception unit 144.

The registration unit 141 performs face information registration processing of the user U. The registration unit 141 controls the camera 160 in accordance with an operation of the user U and captures an image of the face of the user U. The registration unit 141 transmits the face image of the user U to the authentication infrastructure system 400 via the network N and receives the face feature information extracted in the authentication infrastructure system 400 and the issued user ID. The registration unit 141 saves the user ID 1111 and the face feature information 1112 received in the storage unit 110 as the user information 111 in such a way that they are associated with each other. Further, the registration unit 141 transmits the attribute information read out from the non-contact type IC card 102 by the short-range radio transmission/reception unit 144 and the received user ID to the utilization management server 500 via the network N, and receives a registration completion notification that the utilization management server 500 registers the attribute information and the user ID in the utilization management DB 512.

The purchase unit 142 performs electronic application processing (ticket purchase processing). In this example, the purchase unit 142 performs transmission of reservation information of a movie ticket, transmission of information on settlement of the usage fee, accepting of reservation completion, or the like.

The checking unit 143 accepts input of a PIN number of the non-contact type IC card 102 from the user U and outputs the PIN number to the short-range radio transmission/reception unit 144. Further, the checking unit 143 acquires the attribute information from the non-contact type IC card 102 via the short-range radio transmission/reception unit 144. Further, the checking unit 143 may generate code information corresponding to the user ID 1111 and cause the code information to be displayed on the display unit 150. Further, the checking unit 143 may acquire ticket information or the like corresponding to the reservation information from the utilization management server 500 and cause the ticket information or the like to be displayed on the display unit 150.

The short-range radio transmission/reception unit 144 performs radio communication with a reader/writer device capable of performing short-range radio communication by the mode X and the mode Y. Specifically, when the user terminal 101 in which the mode X is ON is within a communication range of a reader/writer of the mode X of the edge terminal 200, the short-range radio transmission/reception unit 144 performs communication with the edge terminal 200 by the mode X via the short-range radio communication IF 131. That is, the short-range radio transmission/reception unit 144 reads the user ID 1111 and the face feature information 1112 from the storage unit 110 and transmits the user ID 1111 and the face feature information 1112 to the edge terminal 200 via the short-range radio communication IF 131. Further, the short-range radio transmission/reception unit 144 performs communication with the edge terminal 200 by the mode Y via the short-range radio communication IF 132 when the user terminal 101 in which the mode Y is ON is within the communication range of the reader/writer of the mode Y of the edge terminal 200. Alternatively, the short-range radio transmission/reception unit 144 communicates with the non-contact type IC card 102 when the non-contact type IC card 102 is held over the user terminal 101 in which the mode Y is ON, that is, when the non-contact type IC card 102 is within the communication range of the short-range radio communication IF 132. For example, the short-range radio transmission/reception unit 144 outputs a PIN number to the non-contact type IC card 102 via the short-range radio communication IF 132 to cause authentication to be performed. The short-range radio transmission/reception unit 144 acquires, when authentication of the PIN number by the non-contact type IC card 102 has succeeded, the attribute information 1113 from the non-contact type IC card 102.

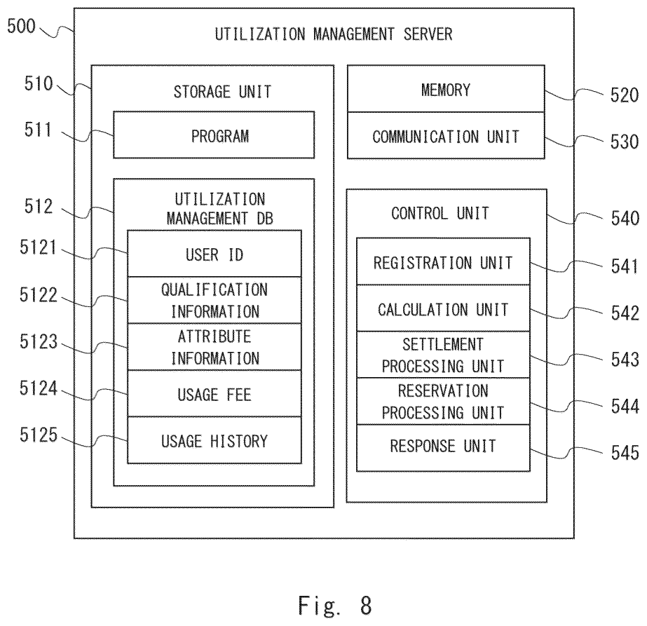

FIG. 8 is a block diagram showing a configuration of the utilization management server 500 according to the third example embodiment. The utilization management server 500 may be implemented in a plurality of servers in a redundant manner, and each functional block may be implemented by a plurality of computers. The utilization management server 500 includes a storage unit 510, a memory 520, a communication unit 530, and a control unit 540. The storage unit 510 is one example of a storing apparatus such as a hard disc or a flash memory. The storage unit 510 stores a program 511 and a utilization management DB 512. The program 511 is a computer program (utilization management program) in which processing for registering and updating the utilization management DB. searching processing, processing regarding a determination as to whether or not a user can be permitted to use the service, or the like are implemented.

The utilization management DB 512 is a database which manages a user ID 5121, qualification information 5122, attribute information 5123, a usage fee 5124, and a usage history 5125 in association with one another. The user ID 5121 is the same as or uniquely corresponds to the above-described user ID 1111. The qualification information 5122 is, for example, information which indicates whether the user corresponding to the user ID 5121 is qualified to use the service or information for certifying that the usage fee of the paid service has been settled. The qualification information 5122 is information issued based on the attribute information 5123. The qualification information 5122 according to this example embodiment is, but not limited to, information on the movie ticket. The attribute information 5123 is information that corresponds to the above-described attribute information 1113. The usage fee 5124 is an amount that is calculated taking into consideration the attribute information 5123 and is settled. The usage history 5125 is history information regarding the use of the service. The usage history 5125 is, for example, the date and time when the service is actually used, the place, the mode of the short-range radio communication in which the face feature information has been acquired by the edge terminal 200, or the like.

The memory 520, which is a volatile storing apparatus such as a RAM, is a storing area for temporarily holding information when the control unit 540 is operated. The communication unit 530 is a communication interface with the network N.

The control unit 540 is a processor that controls each of the components of the utilization management server 500, that is, a control apparatus. The control unit 540 loads the program 511 into the memory 520 from the storage unit 510 to execute the program 511. Accordingly, the control unit 540 implements functions of a registration unit 541, a calculation unit 542, a settlement processing unit 543, a reservation processing unit 544, and a response unit 545.

The registration unit 541 is one example of the above-described registration unit 22. The registration unit 541 receives the user ID and the attribute information from the user terminal 101 and registers the user ID 5121 and the attribute information 5123 that have been received in the utilization management DB 512 in such a way that they are associated with each other. It is assumed that the user terminal 101 transmits, when the attribute information 1113 has been read out from the first storage medium 100-2 that stores the attribute information 1113 of the user U as a result of success in the authentication (by a PIN number or the like), the user ID and the attribute information to the utilization management server 500.

Further, the registration unit 541 registers, when the user U has settled the usage fee, the user ID 5121 and the qualification information 5122 of the use of the service in the utilization management DB 512 in such a way that they are associated with each other. Further, when the user U has used the service, for example, when it has been determined that the user U is permitted to use the service, the registration unit 541 registers the user ID 5121 and the usage history 5125 in the utilization management DB 512 in such a way that they are associated with each other.

The calculation unit 542 is one example of the above-described calculation unit 21. The calculation unit 542 calculates, when the electronic application for the use of the predetermined service including the user ID has been accepted from the user terminal 101, the usage fee of the service discounted based on the attribute information of the user U. As described above, the received user ID corresponds to the first biometric information 1112 of the user U. In particular, the calculation unit 542 may specify the attribute information 5123 associated with the user ID 5121 included in the electronic application from the utilization management DB 512, and calculate the usage fee of the service based on the specified attribute information 5123.

The settlement processing unit 543 performs processing for settling the usage fee based on the settlement information received from the user terminal 101.

The reservation processing unit 544 makes a tentative reservation based on reservation information included in the electronic application. Further, the reservation processing unit 544 issues, when the usage fee settlement processing has been performed by the settlement processing unit 543, qualification information as reservation confirmation processing.

The response unit 545 is one example of the above-described response unit 23. When the response unit 545 has received the user ID from the edge terminal 200, the response unit 545 refers to the utilization management DB 512 and sends a response which is based on the qualification information 5122 associated with the received user ID 5121 to the edge terminal 200. The user ID received by the response unit 545 is the one specified as a result of the user U being succeeded in the biometric authentication based on the first biometric information in the edge terminal 200. Further, the edge terminal 200 acquires the user ID and the first biometric information from the second storage device by a predetermined mode of short-range radio communication, and has performed biometric authentication based on the second biometric information extracted from the captured image of the user U and the first biometric information. Further, the second storage medium, which is carried by the user U and stores the user ID and the first biometric information, is, for example, the above-described storage medium 100.

The response unit 545 may send, in response to a request, modes of short-range radio communication that the plurality of respective edge terminals 200 can support back to the request source. For example, the response unit 545 sends, when it has received the above request from the user terminal 101, modes of short-range radio communication that the respective edge terminals 200 can support back to the user terminal 101.

Further, the response unit 545 may specify, from the utilization management DB 512, the qualification information 5122 associated with the received user ID 5121 and send the specified qualification information 5122 back to the edge terminal 200 as a response. Alternatively, the response unit 545 may refer to the utilization management DB 512, determine whether or not the user can be permitted to use the service based on the qualification information 5122 associated with the received user ID 5121, and send the result of the determination back to the edge terminal 200 as a response.

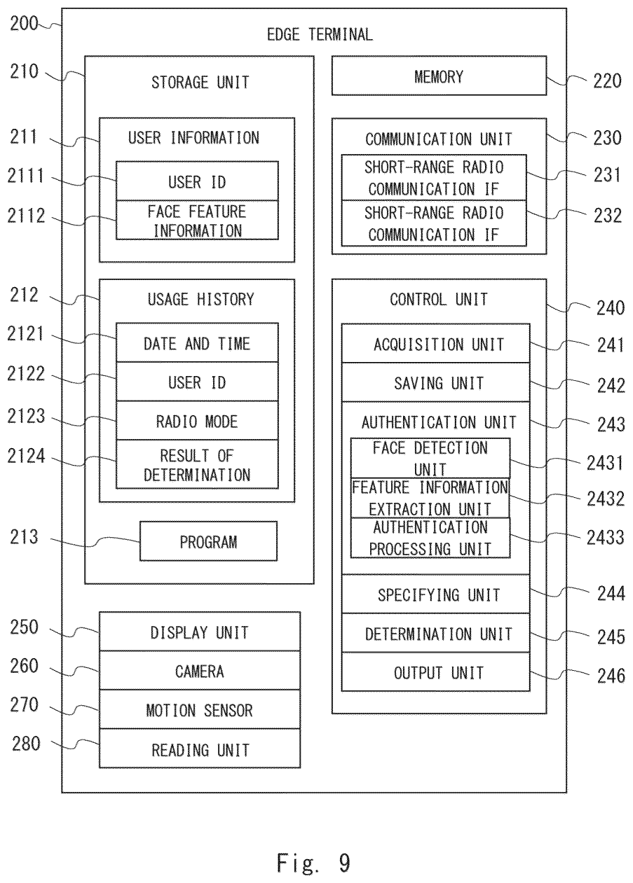

FIG. 9 is a block diagram showing a configuration of the edge terminal 200 according to the third example embodiment. The edge terminal 200 is an information processing apparatus connected to the entry control apparatus 300. The edge terminal 200 may be a tablet terminal or the like. The edge terminal 200 includes a storage unit 210, a memory 220, a communication unit 230, a control unit 240, a display unit 250, a camera 260. a motion sensor 270, and a reading unit 280. The storage unit 210 is one example of a storing apparatus such as a flash memory. The storage unit 210 stores user information 211, a usage history 212. and a program 213. The user information 211 is information in which a user ID 2111 and face feature information 2112 acquired from the storage medium 100 by the predetermined mode of short-range radio communication are associated with each other. The usage history 212 is history information that uses the edge terminal 200 and the entry control apparatus 300. The usage history 212 is, for example, information in which date and time 2121, a user ID 2122, a radio mode 2123, and a result of a determination 2124 are associated with one another. The date and time 2121 is the date and time when the face authentication has succeeded. The user ID 2122 is a user ID specified by the success of the face authentication. The radio mode 2123 is a mode of short-range radio communication in which the user ID 2111 and the face feature information 2112 are acquired. The result of the determination 2124 is a result of the determination as to whether the user can be permitted to use the service. The program 213 is a computer program (utilization control program) in which the utilization control processing and the like according to the second example embodiment are implemented.

Note that the storage unit 210 may store at least the program 213. Therefore, one or both of the user information 211 and the usage history 212 may be saved in an external storing apparatus connected to the edge terminal 200. Further, the memory 220 may store one or both of the user information 211 and the usage history 212.

The memory 220 is a volatile storage apparatus such as a RAM, and is a storing area for temporarily holding information when the control unit 240 operates. The communication unit 230 is a communication interface with the network N. Further, the communication unit 230 may be connected to the network N by wired or wireless communication. Further, the communication unit 230 is also a communication interface with the entry control apparatus 300.

Further, the communication unit 230 can perform radio communication by a plurality of modes of short-range radio communication. Specifically, the communication unit 230 includes short-range radio communication IFs 231 and 232. The short-range radio communication IF 231 establishes connection with and communicates with, by the mode X of the short-range radio communication, an IF of another apparatus of the same mode which is within a predetermined area. The mode X is a mode the same as that in the above-described short-range radio communication IF 131. The short-range radio communication IF 232 establishes connection with and communicates with, by the mode Y of the short-range radio communication, an IF of another apparatus of the same mode which is within a predetermined area. The mode Y is a mode that is the same as that in the short-range radio communication IF 1021 and the short-range radio communication IF 132 described above.

The display unit 250 is a screen such as a liquid crystal display or an Organic Electro-Luminescence (organic EL) display. The display unit 250 displays information instructed from the control unit 240. The camera 260, which is one or more image-capturing apparatuses, captures an image of the face or the like of the user U in accordance with the detection in the motion sensor 270, outputs the captured image to the control unit 240, and displays the image on the display unit 250. The motion sensor 270, which is a sensor that detects a person in a predetermined area, and outputs, when it has detected a person, information indicating that it has detected a person to the camera 260. The reading unit 280 is a transmission/reception unit of radio communication via the short-range radio communication IF 132 by the mode Y of the short-range radio communication. For example, when the non-contact type IC card 102 is present within a communication range of the mode Y, the reading unit 280 reads out data from the non-contact type IC card 102 by the mode Y.

The control unit 240 is a processor that controls each component of the edge terminal 200, that is, a control apparatus. The control unit 240 loads the program 213 into the memory 220 from the storage unit 210 to execute the program 213. Accordingly, the control unit 240 implements functions of an acquisition unit 241, a saving unit 242, an authentication unit 243, a specifying unit 244, a determination unit 245, and an output unit 246.

The acquisition unit 241 is one example of the above-described acquisition unit 11. The acquisition unit 241 acquires, from the storage medium 100 that the user U carries, the user ID and the first biometric information by a predetermined mode of short-range radio communication. In particular, the acquisition unit 241 waits in a state in which it can acquire the user ID and the first biometric information by each of the plurality of modes of the short-range radio communication. That is, it is assumed that the acquisition unit 241 waits in a state in which the modes of X and Y of the short-range radio communication are set to ON and a state in which it can perform establishment of and communication with the radio communication in both the short-range radio communication IFs 231 and 232. Therefore, when the user terminal 101 in which the mode X is activated is within a communication range of the short-range radio communication IF 231, the acquisition unit 241 acquires the user ID 1111 and the face feature information 1112 from the storage medium 100-1 via the short-range radio communication IF 231 by the mode X. Further, when the user terminal 101 in which the mode Y is activated is within the communication range of the short-range radio communication IF 232, the acquisition unit 241 acquires the user ID 1111 and the face feature information 1112 from the storage medium 100-1 via the short-range radio communication IF 232 by the mode Y. That is, the acquisition unit 241 acquires the user ID and the first biometric information by the short-range radio communication with the user terminal 101 by the mode X or Y. Further, when the non-contact type IC card 102 is within the communication range of the short-range radio communication IF 232, the acquisition unit 241 acquires the user ID 1111 and the face feature information 1112 from the storage medium 100-1 via the short-range radio communication IF 232 by the mode Y. That is, the acquisition unit 241 acquires the user ID and the first biometric information by the short-range radio communication with the non-contact type IC card 102 by the mode Y.

The saving unit 242 is one example of the above-described saving unit 12. The saving unit 242 saves the user ID 2111 and the first biometric information 2112 acquired by the acquisition unit 241 in the storage unit 210 as the user information 211 in such a way that they are associated with each other. In particular, when the acquisition unit 241 has acquired the user ID and the first biometric information by one of a plurality of modes of the short-range radio communication, the saving unit 242 saves the user ID 2111 and the first biometric information 2112 that have been acquired in the storage unit 210 in such a way that they are associated with each other. Note that the saving unit 242 may delete the user information 211 after a predetermined period of time has elapsed since it saves the user information 211. That is, the saving unit 242 may temporarily save the user information 211 in the storage unit 210. While the user information 211 is sequentially saved and deleted in the storage unit 210, it is possible that a plurality of pieces of user information 211, that is, two or more pieces of face feature information 2112, may be temporarily saved.

The authentication unit 243 is one example of the above-described authentication unit 13. The authentication unit 243 controls the camera 260 and performs biometric authentication based on the second biometric information extracted from the image of the user U captured by controlling the camera 260 and the first biometric information saved in the user information 211 of the storage unit 210. Specifically, the authentication unit 243 includes a face detection unit 2431, a feature information extraction unit 2432, and an authentication processing unit 2433.

The face detection unit 2431 detects a face area from the image of the user U captured by the camera 260 and outputs a face image corresponding to the detected face area to the feature information extraction unit 2432. The feature information extraction unit 2432 extracts, from the face area (face image) detected by the face detection unit 2431, a plurality of feature points indicating features of the face of the person and calculates the distances between the respective feature points. Then the feature information extraction unit 2432 may collectively extract a set of positions of the plurality of extracted feature points and a set of distances between the respective feature points that have been calculated as face feature information and output the extracted face feature information to the authentication processing unit 2433. The authentication processing unit 2433 collates the face feature information extracted from the feature information extraction unit 2432 with each of one or more pieces of face feature information 2112 in the user information 211, and calculates the degree of match. Then, the authentication processing unit 2433 determines, when the degree of match is equal to or larger than a threshold, that the face authentication has succeeded, and determines, when the degree of match is smaller than the threshold, that the face authentication has failed.

The specifying unit 244 is one example of the above-described specifying unit 14. The specifying unit 244 specifies, from the storage unit 210, the user ID 2111 associated with the face feature information 2112 that has succeeded in the face authentication by the authentication processing unit 2433. Further, the specifying unit 244 may specify the mode of the short-range radio communication at the time of acquisition by the acquisition unit 241, and register the specified mode to be included in the history of acquisition. For example, the specifying unit 244 registers, when the mode X of the short-range radio communication is specified after the face authentication has succeeded, the date and time 2121, the user ID 2122 that has succeeded in the face authentication, and the radio mode 2123 in which the mode X is set in the usage history 212 in such a way that they are associated with one another. Further, the specifying unit 244 may refer to the utilization management DB 512 and specify attribute information due to the qualification information 5122. Specifically, the specifying unit 244 specifies the attribute information 5123 associated with the specified user ID 5121 from the utilization management DB 512 via the network N.

The determination unit 245 is one example of the above-described determination unit 15. The determination unit 245 refers to the utilization management DB 512 to determine whether or not the user U can be permitted to use the service based on the qualification information 5122 associated with the user ID 5121 specified by the specifying unit 244. For example, the determination unit 245 may transmit the user ID to the utilization management server 500 and receive, from the utilization management server 500, the qualification information 5122 associated with the user ID 5121 in the utilization management DB 512. In this case, the determination unit 245 may determine whether or not the user U can be permitted to use the service by determining whether or not the user U is qualified based on the received qualification information. Alternatively, the determination unit 245 may transmit the user ID to the utilization management server 500 and receive the result of the determination as to whether the user U can be permitted to use the service from the utilization management server 500. Then, the determination unit 245 may determine whether or not the user U can be permitted to use the service from the received result of the determination.

The output unit 246 is one example of the above-described output unit 16. The output unit 246 outputs information in accordance with the result of the determination made by the determination unit 245. Specifically, when the result of the determination indicates that the user can be permitted to use the service, the output unit 246 outputs an entry permission notification to the entry control apparatus 300. Further, when the result of the determination indicates that the user can be permitted to use the service, the output unit 246 may output display information indicating that the user can be permitted to use the service. For example, the output unit 246 may output display information indicating that the user U can be permitted to enter the place or can view the movie to a display apparatus (not shown) of the display unit 250 or the entry control apparatus 300 to cause the display apparatus to display the display information. Alternatively, the output unit 246 may output display information indicating that the user U can enter or view the movie to the user terminal 101 which is within the communication range by a predetermined mode of short-range radio communication in which the acquisition unit 241 has acquired the face feature information or the like. Further, the output unit 246 may output a message regarding use of the service to the user terminal 101 within the communication range. Alternatively, the output unit 246 may transmit display information indicating that the user U can be permitted to enter the place or can view the movie to a terminal of a staff member or the like in the movie theater via the network N.

Further, the output unit 246 may output, when the specifying unit 244 has specified attribute information due to the qualification information of the user who has succeeded in the face authentication, the specified attribute information. Then the output unit 246 outputs the attribute information to the output destination in accordance with the attribute information. For example, the output unit 246 may output, when the attribute information indicates an elderly person or a person requiring nursing care, the attribute information to a terminal of a staff member or the like. Further, when the attribute information indicates that the user goes to an elementary school or younger (a person to whom the child fare applies), the output unit 246 may output the attribute information to the entry control apparatus 300 in order to cause a lamp of the entry control apparatus 300 to turn on or cause a speaker to output an alarm sound.

Further, the output unit 246 may output guidance information of the mode of the short-range radio communication used to acquire the user ID and the first biometric information. For example, the output unit 246 may cause the display unit 250 of the edge terminal 200 or the entry control apparatus 300 to display information indicating that the short-range radio communication by the mode Y is performed. In particular, when the face authentication by the authentication unit 243 has failed, the output unit 246 may output guidance information. Accordingly, the user U is able to hold the user terminal 101 over the short-range radio communication IF 232 of the edge terminal 200 or take out the non-contact type IC card 102 to hold it over the short-range radio communication IF 232 to perform short-range radio communication by the mode Y.

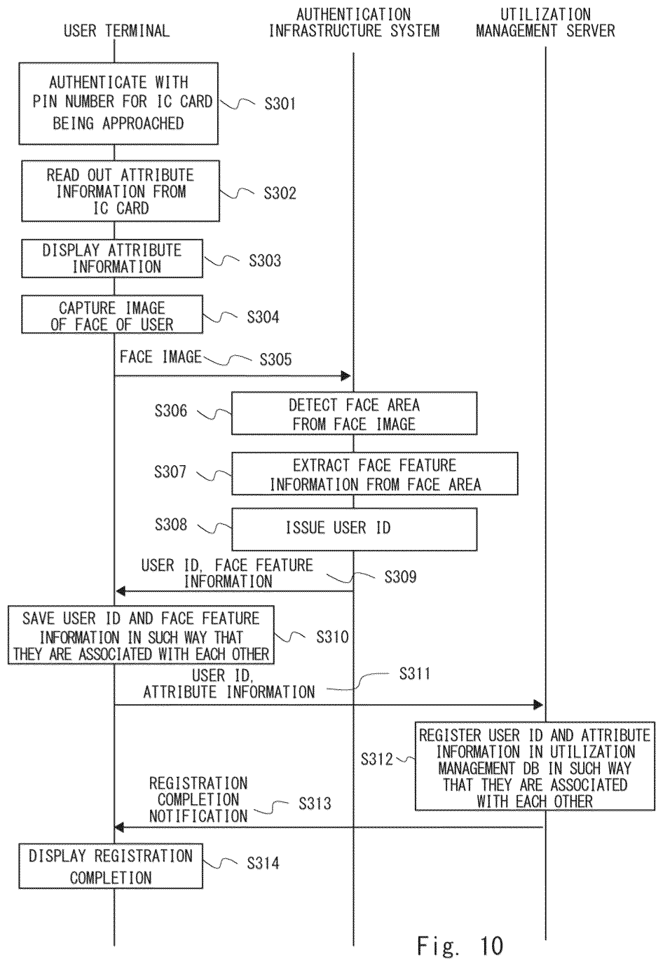

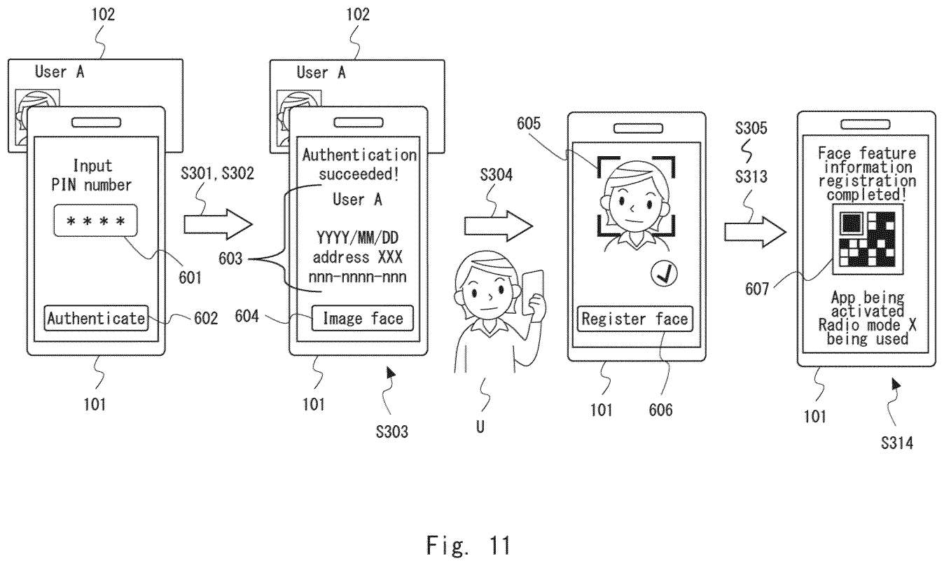

FIG. 10 is a sequence diagram showing a flow of face information registration processing according to the third example embodiment. Further, FIG. 11 is a diagram showing an example of screen transition of face information registration processing in the user terminal according to the third example embodiment. In the following description, FIG. 11 is referred to as appropriate in the description of FIG. 10.

It is assumed here that the user U registers his/her face information by operating the user terminal 101 as preliminary registration for using a predetermined service such as a movie theater. It is further assumed that the user U holds the user terminal 101 and the non-contact type IC card 102. It is further assumed that user information 111 (the user ID 1111 and the face feature information 1112) is not registered in the storage medium 100-1 of the user terminal 101. It is further assumed that the attribute information 1113 and the ID of the identification information on the user U are registered in the storage medium 100-2 of the non-contact type IC card 102, but the user ID 1111 and the face feature information 1112 used for the face authentication are not registered in the storage medium 100-2 of the non-contact type IC card 102.

Further, the user U holds the non-contact type IC card 102 over the reading unit of the short-range radio communication IF 132 (mode Y) of the user terminal 101. Then the user terminal 101 displays a PIN number input screen of the non-contact type IC card 102 on the display unit 150. In accordance therewith, the user terminal 101 accepts input of a PIN number in a PIN number 601 from the user U, and accepts pressing of an authentication button 602. Then the user terminal 101 transmits the PIN number to the non-contact type IC card 102 via the short-range radio communication IF 132 and causes the non-contact type IC card 102 to perform the authentication (S301).

When the authentication in the non-contact type IC card 102 has succeeded, the user terminal 101 reads out the attribute information 1113 from the non-contact type IC card 102 via the short-range radio communication IF 132 (by the mode Y) (S302). Then, the user terminal 101 displays attribute information 603 on the display unit 150 (S303). Then the user terminal 101 accepts pressing of a face image capturing button 604 from the user U. controls the camera 160. and captures an image of the face of the user U (S304). For example, the face image of the user U is captured, like in a face area 605 in FIG. 11. In accordance therewith, the user terminal 101 accepts pressing of a face registration button 606 from the user U, and transmits the captured face image to the authentication infrastructure system 400 via the network N (S305).

The authentication infrastructure system 400 receives the face image from the user terminal 101 via the network N. Then, the authentication infrastructure system 400 detects the face area from the received face image (S306). Then, the authentication infrastructure system 400 extracts, from the detected face area, a plurality of feature points indicating features of the face of the person, and calculates the distances between the respective feature points. Then the authentication infrastructure system 400 collectively extracts a set of the positions of the plurality of extracted feature points and a set of distances between the respective feature points that have been calculated as face feature information (S307). Then, the authentication infrastructure system 400 newly issues a user ID (S308). After that, the authentication infrastructure system 400 sends the issued user ID and the extracted face feature information back to the user terminal 101 via the network N (S309).

The user terminal 101 saves the user ID 1111 and the face feature information 1112 received from the authentication infrastructure system 400 in the storage unit 210 as the user information 211 in such a way that they are associated with each other (S310). Next, the user terminal 101 transmits the received user ID and the attribute information read out in Step S302 to the utilization management server 500 via the network N (S311). Then, the utilization management server 500 registers the received user ID 5121 and the attribute information 5123 in the utilization management DB 512 in such a way that they are associated with each other (S312). After that, the utilization management server 500 transmits a registration completion notification to the user terminal 101 via the network N (S313). The user terminal 101 displays the received information indicating that the registration has been completed on the display unit 150 (S314). At this time, the user terminal 101 may generate two-dimensional code information 607 corresponding to the user ID 1111, and display the two-dimensional code information 607 on the display unit 150. Note that FIG. 11 shows that the radio mode X is available, that is, the setting is ON in the user terminal 101.

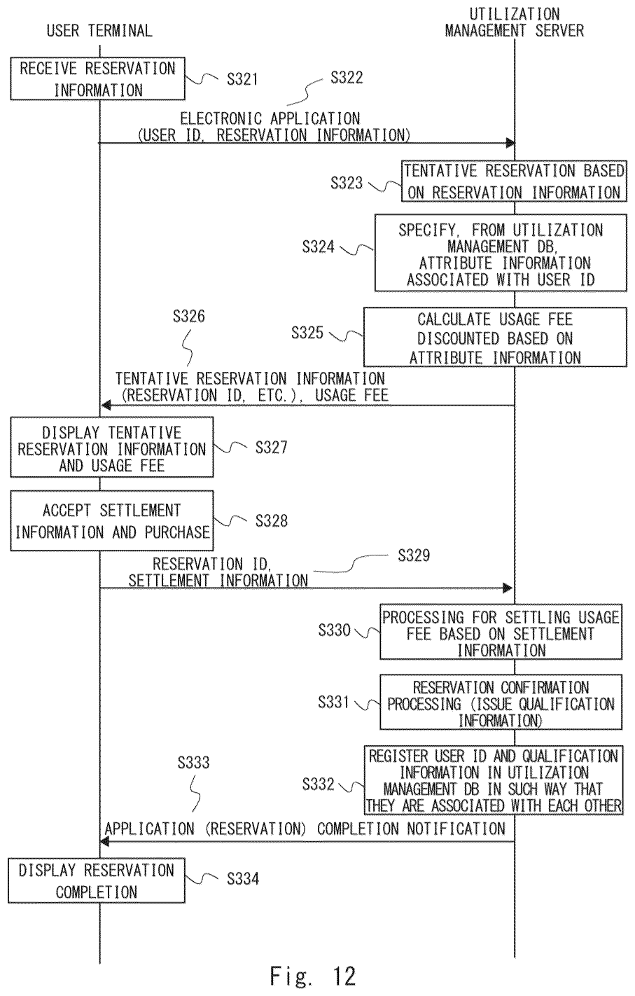

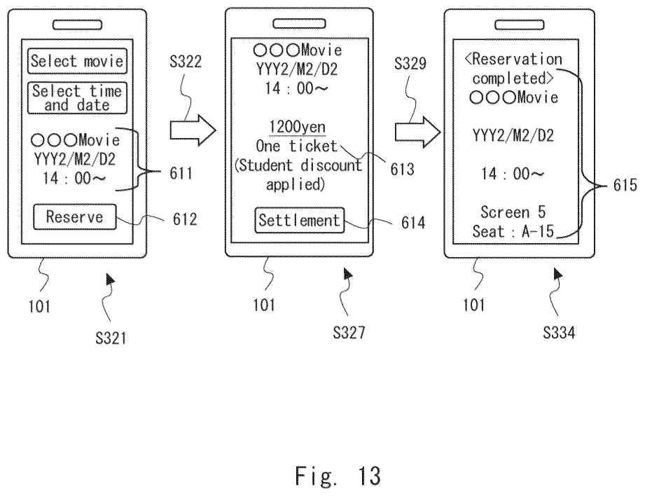

FIG. 12 is a sequence diagram showing a flow of electronic application processing according to the third example embodiment. Further, FIG. 13 is a diagram showing an example of screen transition of ticket purchase processing in the user terminal according to the third example embodiment. In the following description, FIG. 13 is referred to as appropriate in the description of FIG. 12. As a prerequisite, the user U has already executed the face information registration processing in FIG. 10 described above.

First, it is assumed that the user U makes a reservation and performs electronic settlement by an electronic application using the user terminal 101 in order to purchase a ticket for watching a predetermined movie in a movie theater registered in advance.

The user terminal 101 receives reservation information by an input by the user U (S321). For example, the user terminal 101 accepts selection of the movie and the date and time from the user U, and displays reservation information 611 on the display unit 150. Then, the user terminal 101 accepts pressing of a reservation button 612 from the user U. In accordance therewith, the user terminal 101 transmits an electronic application including the user ID 1111 and the reservation information of the user U to the utilization management server 500 via the network N. It is assumed that the reservation information includes the type of the movie, the date and time, the movie theater and the like.

Then, the utilization management server 500 accepts the electronic application from the user terminal 101 via the network N and makes a tentative reservation based on the reservation information (S323). For example, if it is possible to make a reservation at this time in conjunction with a reservation system (not shown), the reservation processing unit 544 of the utilization management server 500 issues a reservation ID and makes a tentative reservation. Specifically, the reservation processing unit 544 determines whether or not there is an empty seat based on the type of the movie, the date and time, the movie theater and the like included in the reservation information, and if a seat can be reserved at this moment, issues a reservation ID, reserves the seat as a tentative reservation, and specifies the standard usage fee. Then, the utilization management server 500 specifies, from the utilization management server 500, the attribute information 5123 associated with the user ID 5121 included in the electronic application (S324). Then, the utilization management server 500 calculates the usage fee discounted based on the specified attribute information 5123 (S325). For example, when the attribute information indicates an elderly person, a person with disabilities, a student or the like, the calculation unit 542 of the utilization management server 500 calculates the usage fee by applying a discount amount or a discount rate in accordance with each attribute information to the standard usage fee. The usage fee in this movie theater may be a regular price (standard) when users purchase tickets at a counter and may be an amount obtained by applying a discount amount or a discount rate less than that in the electronic application when users purchase tickets through an automatic vending machine installed in the movie theater. This configuration may contribute to promoting use of the service that uses the electronic application and the face authentication.

After that, the utilization management server 500 sends tentative reservation information and the usage fee back to the user terminal 101 via the network N (S326). Then, the user terminal 101 displays the tentative reservation information and a usage fee 613 that have been received on the display unit 150 (S327). Then, the user terminal 101 accepts pressing of a settlement button 614 from the user U (S328). In this case, the user terminal 101 transmits the reservation ID and the settlement information 112 to the utilization management server 500 via the network N (S329). When the settlement information 112 is not saved in the storage unit 110, the user terminal 101 may accept the input of the settlement information form the user U.

The utilization management server 500 receives the reservation ID and the settlement information from the user terminal 101 via the network N and performs processing for settling the usage fee based on the settlement information (S330). Then the utilization management server 500 performs reservation confirmation processing (S331). That is, the utilization management server 500 issues digital ticket information in the reservation ID confirmed for the user U as qualification information. Then the utilization management server 500 registers the user ID 5121 received in Step S322 and the qualification information 5122 issued in Step S331 in the utilization management DB 512 in such a way that they are associated with each other (S332). After that, the utilization management server 500 sends an application (reservation) completion notification back to the user terminal 101 via the network N (S333). The user terminal 101 displays the received information indicating that the reservation has been completed on the display unit 150 (S334). FIG. 13 shows that reservation confirmation information 615 is displayed on the display unit 150 of the user terminal 101. While the reservation confirmation information 615 includes, for example, the title of the movie, the date and time, the room (screen), the seat number and so on, this is merely an example.

Next, Example 3-1 in which a user terminal is used and Example 3-2 in which a non-contact type IC card is used in entry processing using face authentication according to the third example embodiment will be described.

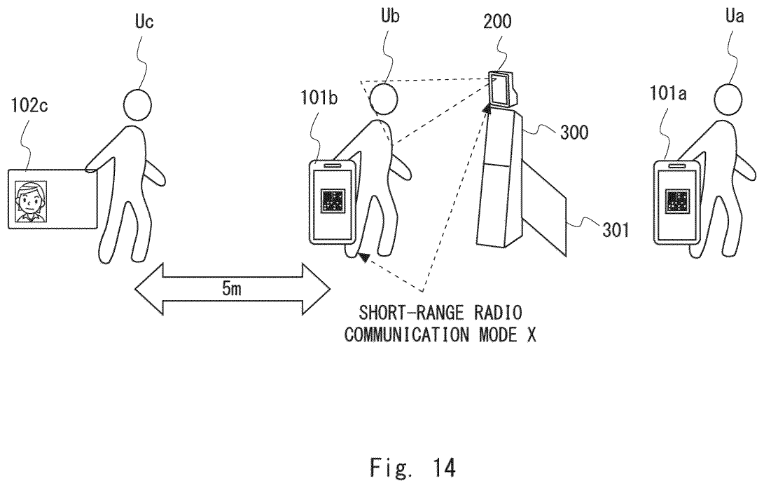

First, Example 3-1 in which a user terminal is used in entry processing using face authentication will be described. FIG. 14 is a diagram for describing a concept of entry processing using the user terminal according to Example 3-1 of the third example embodiment. FIG. 14 shows that, in a state in which the edge terminal 200 and the entry control apparatus 300 are installed, a user Ua who carries a user terminal 101a is permitted to enter the place by face authentication and qualification determination by the edge terminal 200. Next, a user Ub who carries a user terminal 101b enters the place by the mode X of the short-range radio communication, and a user Uc who carries a non-contact type IC card 102e waits to enter the place after the user Ub with a predetermined distance (e.g., 5 m) from the user Ub. Note that the predetermined distance is not limited to 5 m.

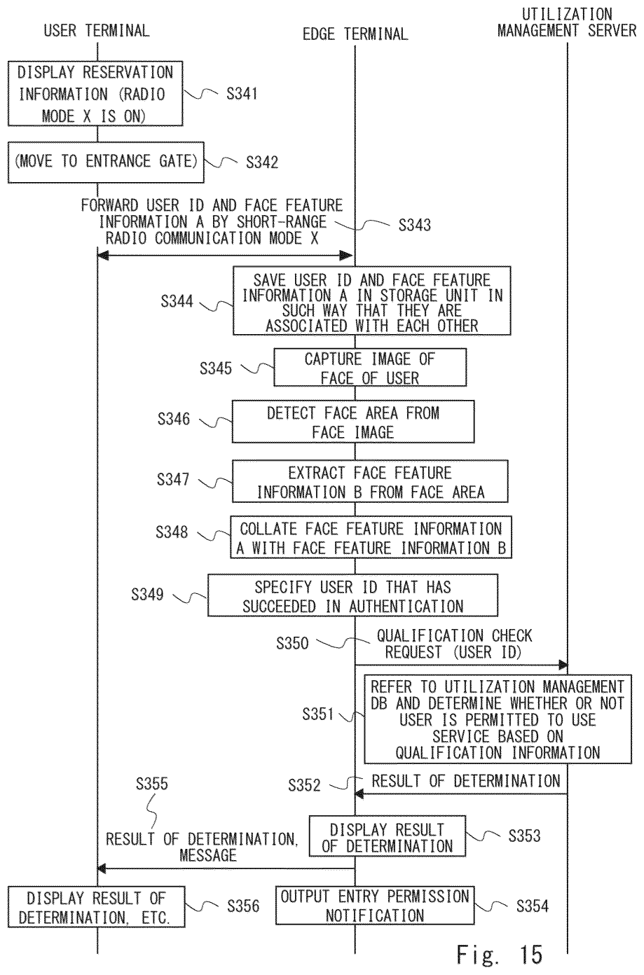

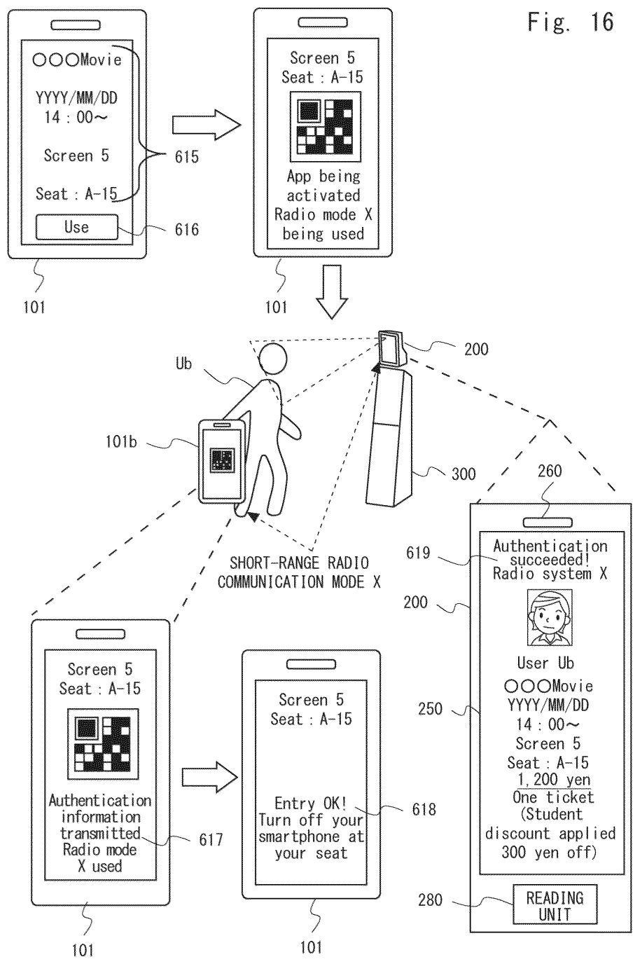

FIG. 15 is a sequence diagram showing a flow of entry processing using the user terminal according to Example 3-1 of the third example embodiment. Further, FIG. 16 is a diagram showing an example of screen transition of entry processing in the user terminal according to Example 3-1 of the third example embodiment. In the following description, FIG. 16 is referred to as appropriate in the description of FIG. 15.

First, the user terminal 101b displays reservation information in accordance with the operation by the user Ub (S341). Specifically, the user terminal 101b causes the above-described reservation confirmation information 615 to be displayed on the display unit 150. Then, the user terminal 101b accepts pressing of a utilization start button 616 from the user Ub and displays the code information and information indicating that the short-range radio communication available is the mode X on the display unit 150. For example, the user terminal 101b may set the mode X to ON in accordance with the pressing of the utilization start button 616. It is sufficient that the user terminal 101b be in a state in which it can perform short-range radio communication by the mode X at this point. The code information may include the user ID and the reservation ID of the user Ub. This is because, if the short-range radio communication does not work well, the edge terminal 200 may be caused to read out code information, thereby enabling entry processing.

Then, the user Ub moves to the entrance gate in the movie theater (the edge terminal 200 and the entry control apparatus 300) while carrying the user terminal 101b (S342). It is also assumed that the user terminal 101b is within the communication range of the short-range radio communication IF 231 by the mode X of the edge terminal 200. At this time, the user ID 1111 and the face feature information 1112 are forwarded from the user terminal 101b to the edge terminal 200 by the mode X of the short-range radio communication (S343). That is, the user terminal 101b transmits the user ID 1111 and the face feature information 1112 read out from the storage medium 100-1 to the edge terminal 200 by the mode X of the short-range radio communication. Note that the user terminal 101b may transmit the user ID 1111 and the face feature information 1112 from the edge terminal 200 in response to a reading request by the mode X of the short-range radio communication.

Then the edge terminal 200 saves the received user ID 2111 and the received face feature information 2112 (face feature information A) in the storage unit 210 as user information 211 in such a way that they are associated with each other (S344). Further, the edge terminal 200 detects the presence of the user Ub by the motion sensor 270 and captures an image of the face of the user Ub by the camera 260 (S345).

Then the face detection unit 2431 detects the face area from the image of the user Ub captured by the camera 260 (S346). Then the feature information extraction unit 2432 extracts face feature information B of the user Ub from the detected face area (S347). Then, the authentication processing unit 2433 collates the face feature information A in the storage unit 210 with the face feature information B extracted in Step S347 (S348) to calculate the degree of match. When the degree of match is equal to or larger than a threshold, the authentication processing unit 2433 determines that the face authentication has succeeded. When the degree of match is smaller than the threshold, the authentication processing unit 2433 determines that the face authentication has failed.

In this example, the explanation will be continued assuming that the face authentication of the user Ub has succeeded. Therefore, the specifying unit 244 specifies, from the storage unit 210, the user ID 2111 (of the user Ub) associated with the face feature information 2112 (face feature information A) that has been succeeded in the face authentication (S349).

Next, the determination unit 245 transmits a qualification verification request including the user ID specified in Step S349 to the utilization management server 500 via the network N (S350). The response unit 545 of the utilization management server 500 specifies the user ID included in the received qualification verification request and searches for the qualification information 5122 associated with the specified user ID 5121 from the utilization management DB 512. Then, the response unit 545 determines whether or not the user is permitted to use the service based on the searched qualification information 5122 (S351). Then, the response unit 545 sends a result of the determination regarding whether or not the user is permitted to use the service back to the edge terminal 200 via the network N (S352). Note that the response unit 545 may send the searched qualification information 5122 back to the edge terminal 200.

The determination unit 245 of the edge terminal 200 sets the result of the determination received from the utilization management server 500 as a result of the determination as to whether or not the user Ub is permitted to use the service. It is assumed, in this example, that it is determined the user Ub is permitted to use the service for viewing (watching) a movie. Then, the output unit 246 displays the result of the determination on the display unit 150 (S353). FIG. 16 shows an example in which a result message 619 is displayed on the display unit 250 of the edge terminal 200. The result message 619 shows an example in which information indicating that authentication has succeeded, the mode of the short-range radio communication in which the user ID and the face feature information are forwarded, and others such as attribute information (name and the like) of the user, qualification information (ticket information, title of the movie, date and time, room, seat number, etc.), the reason for the discount on the usage fee, and discount information are displayed. The discount reasons may include, besides “student discount”, elderly person, person with disabilities, a plurality of times of usage, and the like. The discount information may be an amount of discount, a discount rate (how much discount), or the like. The output unit 246 also outputs an entry permission notification to the entry control apparatus 300 (S354). In accordance therewith, the entry control apparatus 300 opens the gate 301. Accordingly, the user Ub can enter the place.

Further, the output unit 246 transmits a result of the determination and a message regarding the use of the service to the user terminal 101b by the mode X of the short-range radio communication (S355). In accordance therewith, the user terminal 101b displays the received result of the determination and the message regarding the use of the service on the display unit 150 (S356). FIG. 16 shows an example in which result messages 617 and 618 are displayed on the display unit 150 of the user terminal 101b. The result message 617 shows an example in which the mode of the short-range radio communication where the user ID and the face feature information are forwarded, and the like are displayed. The result message 618 shows an example in which information indicating that authentication has succeeded, precautions after being seated, and the like are displayed.

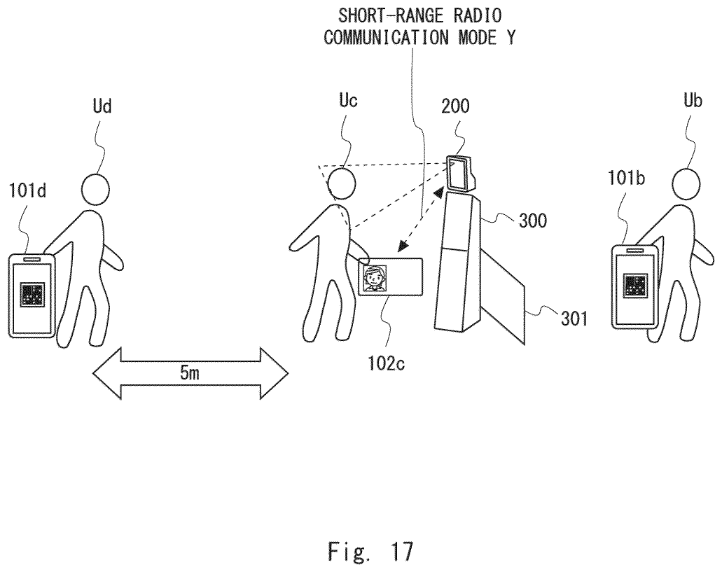

Next, Example 3-2 in which a non-contact type IC card is used in entry processing using face authentication will be described. FIG. 17 is a diagram for describing a concept of entry processing using a non-contact type IC card according to Example 3-2 of the third example embodiment. This shows an example in which the user Ub who carries the user terminal 101b is permitted to enter the place by face authentication and qualification determination by the edge terminal 200 in a state in which the edge terminal 200 and the entry control apparatus 300 are installed. FIG. 17 further shows the next user Uc who carries the non-contact type IC card 102c and is about to enter the place by the mode Y of the short-range radio communication, followed by a user Ud who carries a user terminal 101d and waits to enter the place after the user Uc with a predetermined distance (e.g., 5 m) from the user Uc. Note that the predetermined distance is not limited to 5 m. Note that the storage medium 100-2 of the non-contact type IC card 102c stores a user ID 1111, face feature information 1112, and attribute information 1113. For example, it is assumed that the non-contact type IC card 102 owned by the user Uc writes the user ID 1111 and the face feature information 1112 of the user Uc into the non-contact type IC card 102c by the mode Y in Step S310 in FIG. 10 described above.

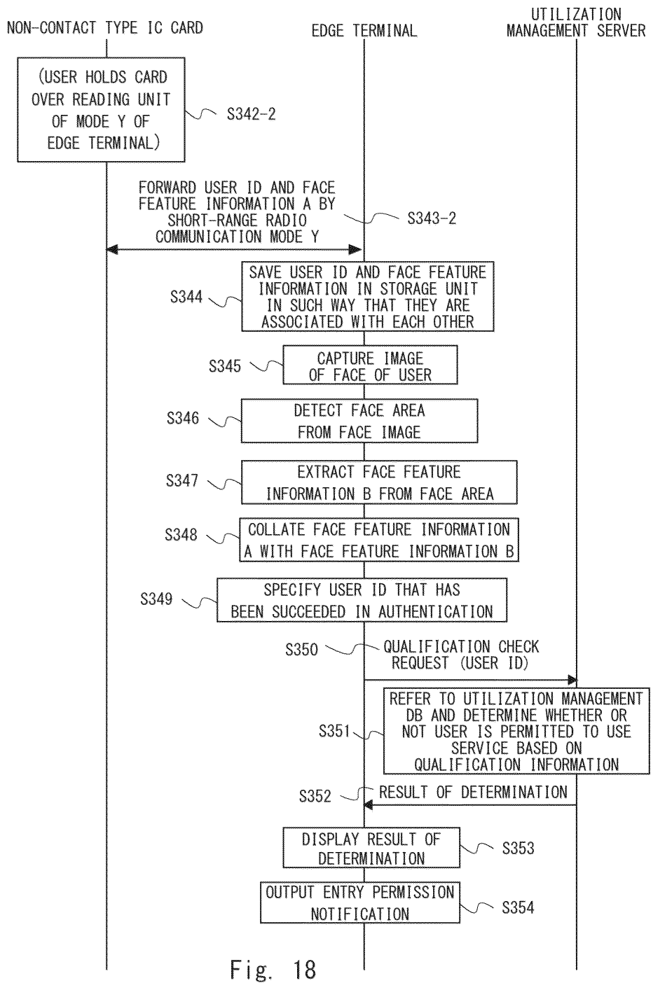

FIG. 18 is a sequence diagram showing a flow of entry processing using a non-contact type IC card according to Example 3-2 of the third example embodiment. First, the user Uc holds the non-contact type IC card 102c over the reading unit of the short-range radio communication IF 232 (mode Y) of the edge terminal 200 (S342-2). Accordingly, the non-contact type IC card 102c enters within a communication range of the short-range radio communication IF 232 (mode Y) by the mode Y. Therefore, the user ID 1111 and the face feature information 1112 are forwarded from the non-contact type IC card 102c to the edge terminal 200 by the mode Y of the short-range radio communication (S343-2). That is, the non-contact type IC card 102c transmits the user ID 1111 and the face feature information 1112 read out from the storage medium 100-2 to the edge terminal 200 by the mode Y of the short-range radio communication. Note that the non-contact type IC card 102c may transmit the user ID 1111 and the face feature information 1112 read out from the storage medium 100-2 in response to a reading request by the mode Y of the short-range radio communication from the edge terminal 200. Since Steps S344 to S3554 are similar to those in FIG. 15 described above, the redundant descriptions will be omitted.

As described above, this example embodiment achieves effects similar to those of the above-described first and second example embodiments. Further, in this example embodiment, the edge terminal 200 supports a plurality of modes of short-range radio communication, whereby it is possible to determine whether or not the user is permitted to use the service using face authentication in a flexible manner depending on the circumstance of the user. Further, face feature information on a user is forwarded from the storage medium carried by the user to the edge terminal by short-range radio communication and saved in the edge terminal without using a database of the face feature information saved in the authentication infrastructure DB on the network, and the above face feature information is used to be collated with face feature information extracted from a face image of a user who is present within a short distance at this time. That is, the face authentication is implemented in local authentication. Accordingly, even when the communication with the authentication infrastructure DB fails, the authentication processing can be continued. Further, it is possible to prevent spoofing with a high probability by using biometric authentication for personal authentication.

Further, the service usage fee is often discounted when the user shows his/her ID. However, since the ID often includes personal information written, engraved, or stamped on it, the user may hesitate to show his/her ID when he/she uses the service. On the other hand, in this example embodiment, among modes of the short-range radio communication, the mode X with a relatively long distance is supported, whereby the user can get a discount without presenting his/her ID to use the service. Therefore, it is possible to promote the spread of the use of the service using biometric authentication. Further, when the user makes an electronic application such as purchasing of a digital ticket via the internet, the user can receive a greater discount on the usage fee, whereby it is possible to further promote the spread of the use of the service that uses biometric authentication. On the other hand, existing code authentication with a plurality of modes of the short-range radio communication is also supported, whereby it is possible to deal with various cases in a flexible manner.

Note that the edge terminal 200 may perform face authentication when a user is detected by the motion sensor 270 regardless of whether the user ID and the face feature information have been acquired by short-range radio communication. Therefore, when the face authentication has failed in Step S348, the user whose image of the face has been captured when he/she tries to enter the place may be different from the rightful owner of the user terminal 101 and the non-contact type IC card 102 carried by the user. Further, cases where the face authentication has failed in Step S348 may include a case where forwarding between the edge terminal 200 and the user terminal 101 or the non-contact type IC card 102 by the short-range radio communication has failed. When, for example, the mode X is OFF in the user terminal 101 or when the user has the user terminal 101 in his/her bag, it is possible that forwarding between the edge terminal 200 and the user terminal 101 cannot be performed since they are outside the communication range of the mode X. Therefore, the edge terminal 200 may preferably output guidance information of the mode of the short-range radio communication when the face authentication has failed in Step S348.

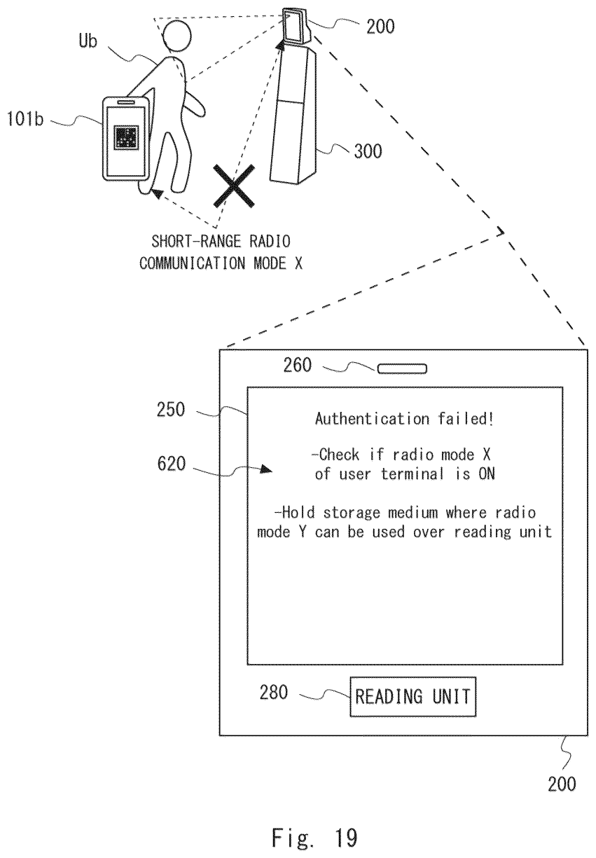

FIG. 19 is a diagram showing a display example of guidance information of the mode of the short-range radio communication in the edge terminal 200 according to the third example embodiment. Guidance information 620 includes information indicating that the authentication has failed, a message for checking whether the mode X of the user terminal is ON, a message for letting the user hold a storage medium (a user terminal or a non-contact type IC card) of the mode Y over the reading unit 280, or the like. However, the guidance information 620 is not limited thereto.

Note that, when there are a plurality of edge terminals 200, the user U may check modes of the short-range radio communication that the respective edge terminals support before he/she enters the place. It is assumed, for example, that the utilization management server 500 saves information on the modes of the short-range radio communication supported by the plurality of respective edge terminals 200-1 to 200-3 installed in the entrance gate in the movie theater in the storage unit 510. Then, the user terminal 101 transmits, in accordance with an operation by the user U, a request for the modes of short-range radio communication that the respective edge terminals can support to the utilization management server 500 via the network N. When the response unit 545 of the utilization management server 500 has received the above request from the user terminal 101, the response unit 545 specifies, from the storage unit 510, the modes of the short-range radio communication that the respective edge terminals 200 can support, generates display information including the specified information, and sends the display information back to the user terminal 101.

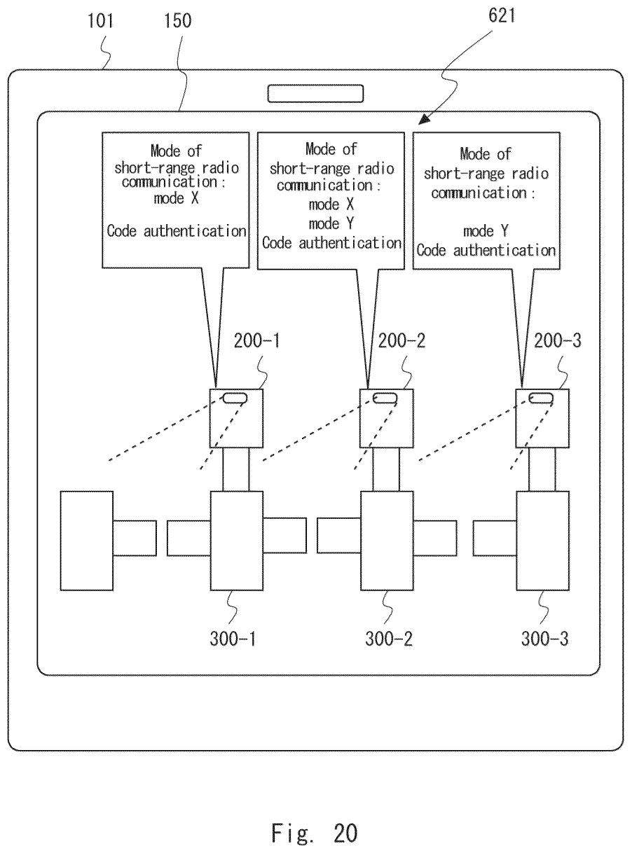

FIG. 20 is a diagram showing a display example of modes of short-range radio communication that the respective edge terminals can support according to the third example embodiment. This shows an example in which the display unit 150 of the user terminal 101 displays supported mode information 621. A set of the edge terminal 200-1 and an entry control apparatus 300-1, a set of the edge terminal 200-2 and an entry control apparatus 300-2, a set of the edge terminal 200-3 and an entry control apparatus 300-3 are arranged in the supported mode information 621 in accordance with the location of installation. The example shown in FIG. 20 shows that the edge terminal 200-1 supports the mode X and the code authentication, the edge terminal 200-2 supports the mode X, the mode Y, and the code authentication, and the edge terminal 200-3 supports the mode Y and the code authentication. In this manner, the user U may use the edge terminal 200 after checking the edge terminal 200 that supports the mode of the short-range radio communication he/she wants to use in advance. The “code authentication” is a mode for causing the camera 260 to read code information corresponding to the above-described user ID to specify the user ID, thereby causing qualification determination to be performed. Therefore, since the code authentication does not use face authentication, a discount fee will not be applied. Therefore, the user U may be motivated to use the mode X or the mode Y that uses the face authentication. On the other hand, by ensuring the code authentication, it is possible to deal with an unpredictable event such as a failure in the short-range radio communication in a flexible manner.

### Fourth Example Embodiment

A fourth example embodiment is a modified example of the above-described third example embodiment. A utilization control terminal (edge terminal) according to the fourth example embodiment is a mobile terminal. Therefore, for example, a staff member who provides a service carries an edge terminal and checks whether or not the user can be permitted to use the service by short-range radio communication with a storage medium carried by the user and face authentication. In the following, an example in which the service is a reserved seat of a train and the staff member is a conductor will be described. The fourth example embodiment can also be applied to another service and another staff member.

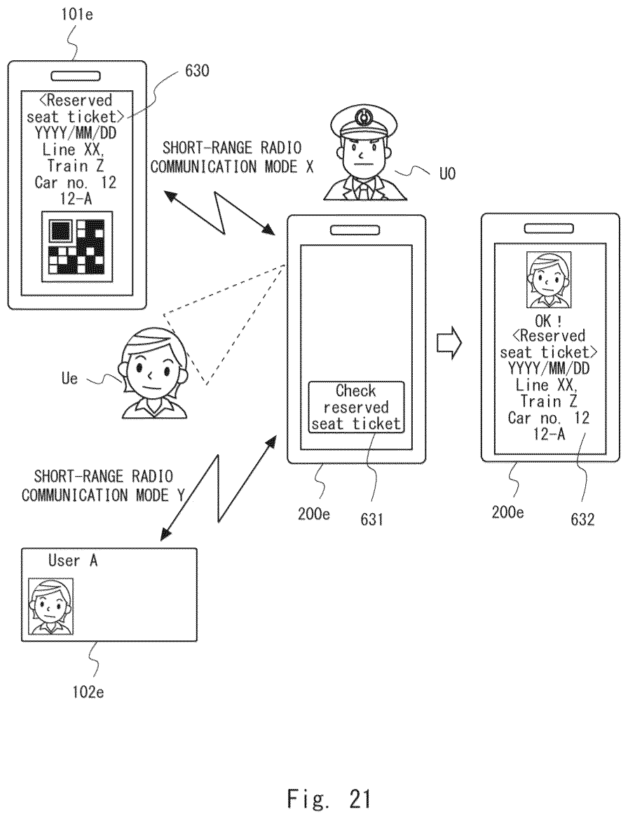

FIG. 21 is a diagram for describing a concept of reserved seat ticket check processing performed by a conductor U0 according to the fourth example embodiment. It is assumed first that a user Ue uses a reserved seat in a reserved seat vehicle in one train. The user Ue carries a user terminal 101e or a non-contact type IC card 102e. Further, the user Ue performs the face information registration processing to purchase a reserved seat ticket and reserved seat ticket purchase processing for the utilization management server 500 described above in advance. In this case, the utilization management server 500 registers a user ID 5121 of the user Ue, qualification information 5122, which is purchase information of the reserved seat ticket, and attribute information 5123 of the user Ue in a utilization management DB 512 in such a way that they are associated with one another.

The conductor U0 carrying an edge terminal 200e looks around the train. The edge terminal 200e, which is a mobile terminal, is different from the above-described edge terminal 200 in that the edge terminal 200e does not include the motion sensor 270 and is not connected to the entry control apparatus 300. It is assumed that the other basic configurations of the edge terminal 200e are similar to those of the edge terminal 200.

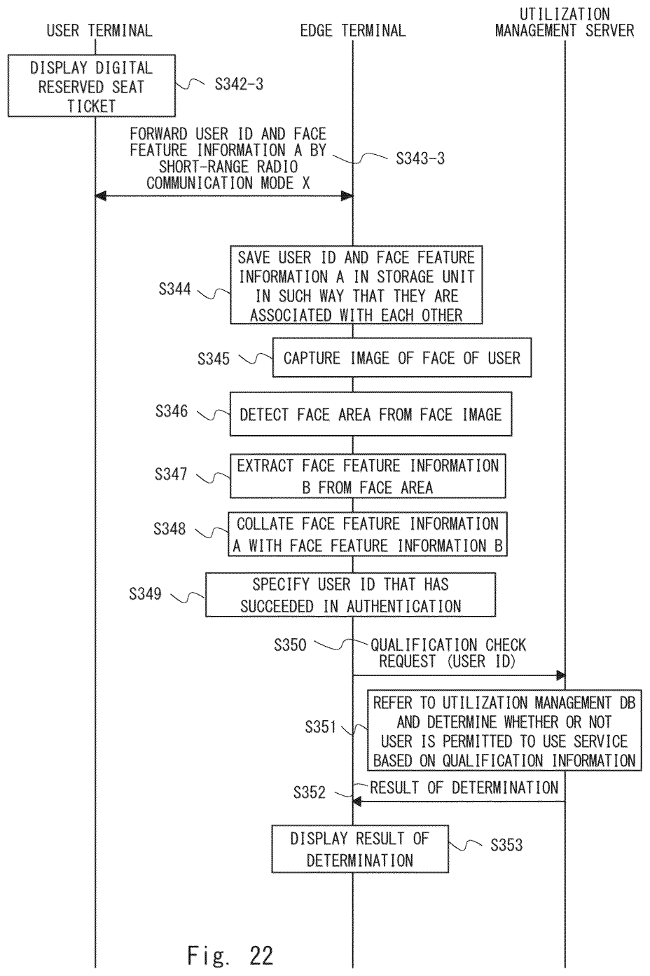

FIG. 22 is a sequence diagram showing a flow of the reserved seat ticket check processing performed by the conductor according to the fourth example embodiment. In the following description. FIG. 21 is referred to as appropriate in the description of FIG. 22. First, the conductor U0 talks to the user Ue in a reserved seat vehicle to check whether or not the user Ue is a legitimate user who has purchased the reserved seat ticket. For example, the user terminal 101e displays a digital reserved seat ticket 630 in accordance with an operation by the user Ue (S342-3).

Then, the conductor U0 causes the user terminal 101e of the user Ue to be within the communication range of the mode X of the edge terminal 200e and presses a reserved seat ticket confirmation button 631 displayed on the screen of the edge terminal 200e. In accordance therewith, a user ID 1111 and face feature information 1112 (face feature information A) are forwarded from the user terminal 101e to the edge terminal 200e by a mode X of the short-range radio communication (S343-3). Then, the edge terminal 200e acquires the user ID and the face feature information in the user terminal 101e by the mode X of the short-range radio communication, and saves the user ID 2111 and the face feature information 2112 in the storage unit 210 in such a way that they are associated with each other (S344).

When the user Ue has presented the non-contact type IC card 102e, the conductor U0 causes the non-contact type IC card 102e of the user Ue to be within the communication range (near a reading unit 280) of the mode Y of the edge terminal 200e, and presses the reserved seat ticket confirmation button 631 displayed on the screen of the edge terminal 200e. In this case, by the mode Y of the short-range radio communication, the user ID 1111 and the face feature information 1112 (face feature information A) are forwarded from the user terminal 101e to the edge terminal 200e.

In accordance therewith, the edge terminal 200e captures an image of the face of the user Ue by the camera 260 (S345), and performs face authentication by collating the face feature information A stored in the storage unit 210 with face feature information B extracted from the face image (S346 to S348). When the face authentication has succeeded, the edge terminal 200e specifies the user ID 2111 (of the user Ue) associated with the face feature information 2112 that has succeeded in the face authentication from the storage unit 210 (S349). Then the edge terminal 200e transmits a qualification verification request including the specified user ID to the utilization management server 500 via the network N (S350) to check whether the user Ue has already purchased a reserved seat ticket. The edge terminal 200e acquires, for example, the qualification information 5122 associated with the user ID 5121 of the user Ue in the utilization management DB 512 (S352), and displays the acquired qualification information 5122 on the display unit 250 (S353). For example, the edge terminal 200e displays the information on the reserved seat ticket received from the utilization management server 500 as a result message 632. The result message 632 includes information indicating that the user Ue has succeeded in the face authentication, information on the reserved seat ticket purchased by the user Ue, etc. However, the result message 632 is not limited thereto. For example, the edge terminal 200e may determine the validity of the reserved seat ticket from the qualification information received from the utilization management server 500. The edge terminal 200e may instead receive the result of the determination made in the utilization management server 500. Accordingly, the conductor U0 can confirm that the user Ue is a legitimate user who has purchased the reserved seat ticket.

Further, if the user Ue has registered his/her face information and purchased his/her reserved seat ticket but sits in a different seat, the conductor U0 can see the result message 632 and then guide the user Ue to the correct seat. Further, in this case, the edge terminal 200e may display, when it accepts input of a reserved seat number from the conductor U0, information indicating that the seat position of this user is different on the result message 632 from the received qualification information as a result of the determination.

Further, when the user Ue has registered his/her face information but has not purchased a reserved seat ticket yet, the edge terminal 200e may receive information indicating that the qualification information has not been registered yet as a result of the determination from the utilization management server 500, and display information indicating that a reserved seat ticket has not been purchased as the result message 632. Further, when the user Ue has not registered his/her face information, the edge terminal 200e may display information indicating that face authentication has failed as the result message 632.

As described above, according to this example embodiment as well, effects similar to those of the above-described first and second example embodiments are achieved. Further, in this example embodiment, like in the above-described third example embodiment, the edge terminal 200e supports a plurality of modes of short-range radio communication and implements local authentication. It is therefore possible to achieve effects similar to those in the third example embodiment.

Further, when a user purchases a reserved seat ticket through an electronic application, the user may receive a more discount than that in a case where he/she purchases the ticket at a ticket counter or a vending machine, whereby effects similar to those in the third example embodiment may be achieved. Further, according to the fourth example embodiment, the edge terminal 200e is a mobile terminal. Therefore, staff members or the like may determine eligibility for various kinds of services in a flexible and easy way, regardless of the location.

Further, according to this example embodiment, the conductor is able to easily grasp qualification information (seat information) of the user by performing face authentication on the face information (face feature information) acquired by communication with the user terminal or the non-contact type IC card of the user and face information (face feature information) obtained by capturing an image of the user without asking the user to take out a passenger ticket, a reserved seat ticket or the like. It is therefore possible for the conductor to easily check whether the user is seating in an appropriate seat. Accordingly, a person who boards the train with a user terminal or a non-contact type IC card of another person will fail in the face authentication, whereby it is possible to reduce spoofing or unauthorized boarding.

### Fifth Example Embodiment

A fifth example embodiment is an additional example of the above-described third or fourth example embodiment. A user terminal 101 may write a user ID and face feature information issued for a non-contact type IC card 102.

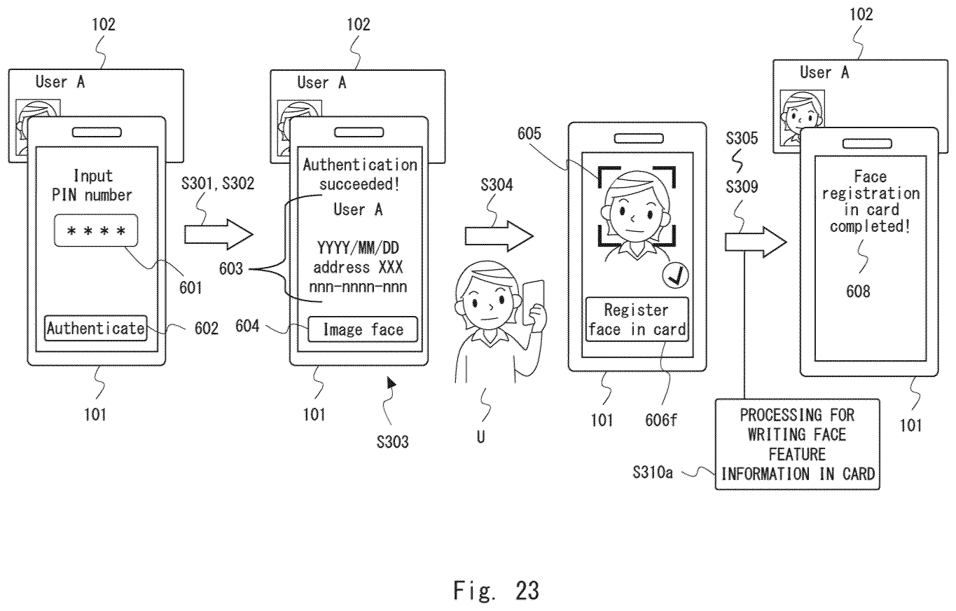

FIG. 23 is a diagram showing an example of screen transition of processing for writing feature information in the non-contact type IC card 102 according to the fifth example embodiment. As a prerequisite, face information registration processing has been performed, like in Steps S301 to S304 in FIG. 10 described above. Then, a user U presses a face registration button 606f of the user terminal 101. In accordance therewith, the face feature information is extracted from a face image in an authentication infrastructure system 400, and the user terminal 101 receives the issued user ID and the extracted face feature information, like in Steps S305 to S309 described above.

At this time, the user terminal 101 continuously performs processing for writing face feature information in the non-contact type IC card 102 (S310a). Specifically, the user terminal 101 associates a received user ID 1111 with received face feature information 1112 and writes the associated information in a storage medium 100-2 of the non-contact type IC card 102 by a mode Y through a short-range radio communication IF 132. The user terminal 101 displays information indicating that face registration in the card has been completed (a face registration completion message 608). In the following process, the user terminal 101 performs Step S311 and the subsequent steps described above.

Accordingly, the user U is able to determine qualification for the face authentication and the use of the service by holding the non-contact type IC card 102 over the reading unit 280 of the edge terminal 200 or the like instead of using the user terminal 101.

### Other Example Embodiments

Note that the user terminal 101 may write qualification information in the storage medium 100. For example, in Step S333 in FIG. 12 described above, the user terminal 101 may receive issued qualification information from the utilization management server 500, and save the qualification information associated with the user ID in the storage medium 100. Further, the user terminal 101 or the non-contact type IC card 102 may forward the qualification information along with the user ID and the face feature information (biometric information) by short-range radio communication with the edge terminal 200 or the like.

Further, while a set of the user ID and the qualification information are registered in a database (utilization management DB) of the utilization management server at the time of registration or reservation in the above-described second to fifth example embodiments, the qualification information may not be registered in the utilization management DB. Alternatively, as described above, the user terminal 101 may register the qualification information in the storage medium 100 in such a way that the qualification information is associated with the user ID. Accordingly, the edge terminal can acquire the qualification information and the attribute information described above along with the face feature information and the user ID from the user terminal or the non-contact type IC card when the user uses the service. Accordingly, the edge terminal is able to output the result of the determination by local communication alone between the user terminal and the edge terminal without performing communication with the utilization management server.

Further, when there is a discount on the usage fee based on the attribute information, actual settlement processing may not be performed at the time of reservation, unlike in Step S330 in FIG. 12 described above. In this case, the settlement processing may be performed at a timing when, for example, it is confirmed that the user who has succeeded in the face authentication when he/she uses a service is a pre-registered user who is qualified for a discount (a student or an elderly person). Accordingly, it is possible to prevent a user from fraudulently making a reservation while receiving a discount at the time of reservation and completing the settlement, and a user who is not qualified for a discount from making unauthorized use of the service (spoofing) at the time of using the service.

Further, at the time of reservation by the electronic application in FIG. 12. the user terminal may acquire attribute information from the digital ID and transmit an electronic application, which includes attribute information, along with the user ID and the reservation information. That is, the person who makes the reservation may prove, at the time of making the reservation, that he/she is qualified for a discount by presenting attribute information recorded in a digital ID such as a license, a passport, a student identification card, or My Number Card (Individual Number Card). Further, the user terminal may read out face feature information from the digital ID and transmit an electronic application, which includes face feature information, along with the user ID. the reservation information, and the attribute information. Further, it may be certified that the user is qualified for a discount by collating the face feature information acquired from the digital ID with the captured face information.

While face authentication is performed as personal authentication (identity checking authentication, identity authentication, identity specifying processing, or the like) in the above-described example embodiments, the personal authentication may be another biometric authentication using biometric information. Another technique that uses a captured image of a person can be applied to the biometric authentication and the biometric information. For example, data (features) calculated from physical characteristics unique to an individual, such as fingerprints, voice prints, veins, retina, iris of an eye, or palm pattern, may be used as the biometric information. Further, the biometric authentication may be authentication in which feature information indicating physical features of a person are extracted from the captured image of a part of the user's body. the feature information registered in advance is collated with the extracted feature information, and it is determined that authentication has succeeded when the degree of match is equal to or larger than a threshold. For example, the biometric authentication may be authentication based on an external shape of the person. In this case, the feature information is information regarding the external shape of the person such as information indicating features such as the body shape, height, clothing, etc. Further, other identity authentication may be applied in place of biometric authentication. The biometric information may be other identity authentication information. While the identity authentication information may be, for example, a user ID, a combination of an ID and a password, description on an identification card such as My Number Card or a driver's license (an identification number or the like, or a password), an electronic certificate, code information, or the like, this is merely an example. The code information may be a two-dimensional code such as a QR code (registered trademark).

In the aforementioned examples, the program includes instructions (or software codes) that, when loaded into a computer, cause the computer to perform one or more of the functions described in the example embodiments. The program may be stored in a non-transitory computer readable medium or a tangible storage medium. By way of example, and not a limitation, computer readable media or tangible storage media can include a random-access memory (RAM), a read-only memory (ROM), a flash memory, a solid-state drive (SSD) or other types of memory technologies, a CD-ROM, a digital versatile disc (DVD), a Blu-ray (registered trademark) disc or other types of optical disc storage, and magnetic cassettes, magnetic tape, magnetic disk storage or other types of magnetic storage devices. The program may be transmitted on a transitory computer readable medium or a communication medium. By way of example, and not a limitation, transitory computer readable media or communication media can include electrical, optical, acoustical, or other forms of propagated signals.

Note that the present disclosure is not limited to the above-described example embodiments and may be changed as appropriate without departing from the spirit of the present disclosure. Further, the present disclosure may be performed by combining each of the example embodiments as appropriate.

The whole or part of the example embodiments disclosed above can be described as, but not limited to, the following supplementary notes.

### (Supplementary Note A1)

A utilization control terminal comprising:
acquiring means for acquiring, from a storage medium that is carried by a predetermined user and stores a user ID and first biometric information of the user, the user ID and the first biometric information by a predetermined mode of short-range radio communication;
saving means for saving the user ID and the first biometric information in a storing apparatus in such a way that they are associated with each other;
authentication means for performing biometric authentication based on second biometric information extracted from a captured image of the user and the first biometric information saved in the storing apparatus;
specifying means for specifying, from the storing apparatus, a user ID associated with the first biometric information that has succeeded in the biometric authentication;
determination means for referring to a database in which the user ID and qualification information on the use of a service by the user are registered in such a way that they are associated with each other to determine, based on the qualification information associated with the specified user ID, whether or not the user is permitted to use the service; and
output means for outputting information in accordance with a result of the determination made by the determination means.

### (Supplementary Note A2)

The utilization control terminal according to Supplementary Note A1, wherein
the acquiring means waits in a state in which it can acquire the user ID and the first biometric information by each of a plurality of modes of the short-range radio communication, and
the saving means saves, when the acquiring means has acquired the user ID and the first biometric information by one of the plurality of modes, the user ID and the first biometric information that have been acquired in the storing apparatus in such a way that they are associated with each other.

### (Supplementary Note A3)

The utilization control terminal according to Supplementary Note A1 or A2, wherein the qualification information is information issued based on attribute information of the user.

### (Supplementary Note A4)

The utilization control terminal according to any one of Supplementary Notes A1 to A3, wherein the specifying means specifies a mode of the short-range radio communication at the time of acquisition by the acquiring means and registers the specified mode in such a way that the specified mode is included in a history of acquisition.

### (Supplementary Note A5)

The utilization control terminal according to any one of Supplementary Notes A1 to A4, wherein the output means outputs, when the result of the determination indicates that the user is permitted to use the service, an entry permission notification to an entry control apparatus that controls an entry of the user.

### (Supplementary Note A6)

The utilization control terminal according to any one of Supplementary Notes A1 to A5, wherein the output means outputs, when the result of the determination indicates that the user is permitted to use the service, display information indicating that the user is permitted to use the service.

### (Supplementary Note A7)

The utilization control terminal according to any one of Supplementary Notes A1 to A6, wherein
the specifying means refers to the database to specify attribute information due to qualification information associated with the specified user ID, and
the output means outputs the specified attribute information.

### (Supplementary Note A8)

The utilization control terminal according to Supplementary Note A7, wherein the output means outputs the attribute information to an output destination in accordance with the specified attribute information.

### (Supplementary Note A9)

The utilization control terminal according to any one of Supplementary Notes A1 to A8, wherein the output means outputs guidance information on a mode of the short-range radio communication used to acquire the user ID and the first biometric information.

### (Supplementary Note A10)

The utilization control terminal according to Supplementary Note A9, wherein the output means outputs the guidance information when the biometric authentication has failed.

### (Supplementary Note A11)

The utilization control terminal according to any one of Supplementary Notes A1 to A10, wherein
the storage medium is mounted on a user terminal capable of performing short-range radio communication by a predetermined mode, and
the acquiring means acquires the user ID and the first biometric information by short-range radio communication with the user terminal by the predetermined mode.

### (Supplementary Note A12)

The utilization control terminal according to Supplementary Note A11, wherein the output means outputs, when the result of the determination indicates that the user is permitted to use the service, a message regarding a use of the service to the user terminal.

### (Supplementary Note A13)

The utilization control terminal according to any one of Supplementary Notes A1 to A10, wherein
the storage medium is a non-contact type Integrated Circuit (IC) card capable of performing short-range radio communication by a predetermined mode, and
the acquiring means acquires the user ID and the first biometric information by short-range radio communication with the non-contact type IC card by the predetermined mode.

### (Supplementary Note A14)

The utilization control terminal according to any one of Supplementary Notes A1 to A13, wherein the utilization control terminal is a mobile terminal.

### (Supplementary Note B1)

A utilization control system comprising:
a database in which a user ID of a predetermined user and qualification information on a use of a service by the user are registered in such a way that they are associated with each other; and
a utilization control terminal capable of performing short-range radio communication by one or more modes, wherein
the utilization control terminal includes:
   acquiring means for acquiring, from a storage medium that is carried by the user and stores the user ID and first biometric information, the user ID and the first biometric information by a predetermined mode of short-range radio communication;
   saving means for saving the user ID and the first biometric information in a storing apparatus in such a way that they are associated with each other;
   authentication means for performing biometric authentication based on second biometric information extracted from a captured image of the user and the first biometric information saved in the storing apparatus;
   specifying means for specifying, from the storing apparatus, a user ID associated with the first biometric information that has succeeded in the biometric authentication;
   determination means for referring to the database to determine, based on the qualification information associated with the specified user ID, whether or not the user is permitted to use the service; and
   output means for outputting information in accordance with a result of the determination made by the determination means.

### (Supplementary Note B2)

The utilization control system according to Supplementary Note B1, wherein
the acquiring means waits in a state in which it can acquire the user ID and the first biometric information by each of a plurality of modes of the short-range radio communication, and
the saving means saves, when the acquiring means has acquired the user ID and the first biometric information by one of the plurality of modes, the user ID and the first biometric information that have been acquired in the storing apparatus in such a way that they are associated with each other.

### (Supplementary Note C1)

A utilization control method causing a computer to execute:
acquire, from a storage medium that is carried by a predetermined user and stores a user ID and first biometric information of the user, the user ID and the first biometric information by a predetermined mode of short-range radio communication;
saving the user ID and the first biometric information in a storing apparatus in such a way that they are associated with each other;
performing biometric authentication based on second biometric information extracted from a captured image of the user and the first biometric information saved in the storing apparatus;
specifying, from the storing apparatus, a user ID associated with the first biometric information that has succeeded in the biometric authentication;
referring to a database in which the user ID and qualification information on the use of a service by the user are registered in such a way that they are associated with each other to determine, based on the qualification information associated with the specified user ID, whether or not the user is permitted to use the service; and
outputting information in accordance with a result of the determination that has been determined.

### (Supplementary Note D1)

A non-transitory computer readable medium storing a utilization control program for causing a computer to execute:
acquiring processing for acquiring, from a storage medium that is carried by a predetermined user and stores a user ID and first biometric information of the user, the user ID and the first biometric information by a predetermined mode of short-range radio communication;
saving processing for saving the user ID and the first biometric information in a storing apparatus in such a way that they are associated with each other;
authentication processing for performing biometric authentication based on second biometric information extracted from a captured image of the user and the first biometric information saved in the storing apparatus;
specifying processing for specifying, from the storing apparatus, a user ID associated with the first biometric information that has succeeded in the biometric authentication;
determination processing for referring to a database in which the user ID and qualification information on the use of a service by the user are registered in such a way that they are associated with each other to determine, based on the qualification information associated with the specified user ID, whether or not the user is permitted to use the service; and
output processing for outputting information in accordance with a result of the determination made by the determination processing.

### (Supplementary Note E1)

A utilization management server comprising:
calculation means for calculating, when an electronic application for using a predetermined service including a user ID corresponding to first biometric information on a predetermined user is accepted. a usage fee of the service discounted based on attribute information of the user;
registration means for registering, when the user has settled the usage fee, the user ID and qualification information for the use of the service in a database in such a way that they are associated with each other; and
response means for referring to the database when a user ID specified as a result of the user being succeeded in biometric authentication which is based on the first biometric information has been received from a utilization control terminal of the service, and sending a response which is based on the qualification information associated with the received user ID to the utilization control terminal.

### (Supplementary Note E2)

The utilization management server according to Supplementary Note E1, wherein
the registration means:
   receives, from a user terminal in which the attribution information of the user has been read out from a first storage medium that stores the attribute information of the user as a result of successful authentication, the user ID and the attribute information; and
   registers the user ID and the attribute information that have been received in the database in such a way that they are associated with each other, and
the calculation means:
   specifies, from the database, attribute information associated with the user ID included in the electronic application; and
   calculates the usage fee of the service based on the specified attribute information.

### (Supplementary Note E3)

The utilization management server according to Supplementary Note E1 or E2, wherein the response means receives the user ID specified by a successful biometric authentication from the utilization control terminal in which the user ID and the first biometric information are acquired from a second storage medium that is carried by the user and stores the user ID and the first biometric information by a predetermined mode of short-range radio communication and biometric authentication has been performed based on second biometric information extracted from a captured image of the user and the first biometric information.

### (Supplementary Note E4)

The utilization management server according to any one of Supplementary Notes E1 or E3, wherein the response means sends, in response to a request, modes of short-range radio communication that a plurality of respective utilization control terminals can support back to a request source.

### (Supplementary Note E5)

The utilization management server according to any one of Supplementary Notes E1 or E4, the response means specifies the qualification information associated with the user ID received from the database, and sends the specified qualification information back to the utilization control terminal as the response.

### (Supplementary Note E6)

The utilization management server according to any one of Supplementary Notes E1 or E4, wherein the response means refers to the database, determines, based on the qualification information associated with the received user ID, whether or not the user is permitted to use the service, and sends a result of the determination back to the utilization control terminal as the response.

### (Supplementary Note F1)

A utilization management method causing a computer to:
calculate, when an electronic application for using a predetermined service including a user ID corresponding to first biometric information on a predetermined user is accepted, a usage fee of the service discounted based on attribute information of the user;
register, when the user has settled the usage fee, the user ID and qualification information for the use of the service in a database in such a way that they are associated with each other; and
refer to the database when a user ID specified as a result of the user being succeeded in biometric authentication which is based on the first biometric information has been received from a utilization control terminal of the service, and send a response which is based on the qualification information associated with the received user ID to the utilization control terminal.

### (Supplementary Note G1)

A non-transitory computer readable medium storing a utilization management program for causing a computer to execute:
calculation processing for calculating, when an electronic application for using a predetermined service including a user ID corresponding to first biometric information on a predetermined user is accepted, a usage fee of the service discounted based on attribute information of the user;
registration processing for registering, when the user has settled the usage fee, the user ID and qualification information for the use of the service in a database in such a way that they are associated with each other; and
response processing for referring to the database when a user ID specified as a result of the user being succeeded in biometric authentication which is based on the first biometric information has been received from a utilization control terminal of the service, and sending a response which is based on the qualification information associated with the received user ID to the utilization control terminal.

While the present invention has been described above with reference to the example embodiments (and Examples), the present invention is not limited to the above-described example embodiments (and Examples). Various changes that can be understood by those skilled in the art within the scope of the present invention can be made to the configurations and the details of the present invention.

### REFERENCE SIGNS LIST

1 UTILIZATION CONTROL TERMINAL
11 ACQUISITION UNIT
12 SAVING UNIT
13 AUTHENTICATION UNIT
14 SPECIFYING UNIT
15 DETERMINATION UNIT
16 OUTPUT UNIT
2 UTILIZATION MANAGEMENT SERVER
21 CALCULATION UNIT
22 REGISTRATION UNIT
23 RESPONSE UNIT
1000 UTILIZATION CONTROL SYSTEM
N NETWORK
U USER
101 USER TERMINAL
102 NON-CONTACT TYPE IC CARD
100 STORAGE MEDIUM
100-1 STORAGE MEDIUM
100-2 STORAGE MEDIUM
1111 USER ID
1112 FACE FEATURE INFORMATION
1113 ATTRIBUTE INFORMATION
1021 SHORT-RANGE RADIO COMMUNICATION IF
1022 RW CONTROL UNIT
110 STORAGE UNIT
111 USER INFORMATION
112 SETTLEMENT INFORMATION
113 PROGRAM
120 MEMORY
130 COMMUNICATION UNIT
131 SHORT-RANGE RADIO COMMUNICATION IF
132 SHORT-RANGE RADIO COMMUNICATION IF
140 CONTROL UNIT
141 REGISTRATION UNIT
142 PURCHASE UNIT
143 CHECKING UNIT
144 SHORT-RANGE RADIO TRANSMISSION/RECEPTION UNIT
150 DISPLAY UNIT
160 CAMERA
200 EDGE TERMINAL
210 STORAGE UNIT
211 USER INFORMATION
2111 USER ID
2112 FACE FEATURE INFORMATION
212 USAGE HISTORY
2121 DATE AND TIME
2122 USER ID
2123 RADIO MODE
2124 RESULT OF DETERMINATION
213 PROGRAM
220 MEMORY
230 COMMUNICATION UNIT
231 SHORT-RANGE RADIO COMMUNICATION IF
232 SHORT-RANGE RADIO COMMUNICATION IF
240 CONTROL UNIT
241 ACQUISITION UNIT
242 SAVING UNIT
243 AUTHENTICATION UNIT
2431 FACE DETECTION UNIT
2432 FEATURE INFORMATION EXTRACTION UNIT
2433 AUTHENTICATION PROCESSING UNIT
244 SPECIFYING UNIT
245 DETERMINATION UNIT
246 OUTPUT UNIT
250 DISPLAY UNIT
260 CAMERA
270 MOTION SENSOR
280 READING UNIT
300 ENTRY CONTROL APPARATUS
301 GATE
400 AUTHENTICATION INFRASTRUCTURE SYSTEM
500 UTILIZATION MANAGEMENT SERVER
510 STORAGE UNIT
511 PROGRAM
512 UTILIZATION MANAGEMENT DB
5121 USER ID
5122 QUALIFICATION INFORMATION
5123 ATTRIBUTE INFORMATION
5124 USAGE FEE
5125 USAGE HISTORY
520 MEMORY
530 COMMUNICATION UNIT
540 CONTROL UNIT
541 REGISTRATION UNIT
542 CALCULATION UNIT
543 SETTLEMENT PROCESSING UNIT
544 RESERVATION PROCESSING UNIT
545 RESPONSE UNIT
601 PIN NUMBER
602 AUTHENTICATION BUTTON
603 ATTRIBUTE INFORMATION
604 FACE IMAGE CAPTURING BUTTON
605 FACE AREA
606 FACE REGISTRATION BUTTON
606f FACE REGISTRATION BUTTON
607 CODE INFORMATION
608 FACE REGISTRATION COMPLETION MESSAGE
611 RESERVATION INFORMATION
612 RESERVATION BUTTON
613 USAGE FEE
614 SETTLEMENT BUTTON
615 RESERVATION CONFIRMATION INFORMATION
616 UTILIZATION START BUTTON
617 RESULT MESSAGE
618 RESULT MESSAGE
619 RESULT MESSAGE
620 GUIDANCE INFORMATION
621 SUPPORTED MODE INFORMATION
630 DIGITAL RESERVED SEAT TICKET
631 RESERVED SEAT TICKET CONFIRMATION BUTTON
632 RESULT MESSAGE
Ua USER
Ub USER
Uc USER
Ud USER
Ue USER
U0 CONDUCTOR
101a USER TERMINAL
101b USER TERMINAL
102c NON-CONTACT TYPE IC CARD
101d USER TERMINAL
101e USER TERMINAL
102e NON-CONTACT TYPE IC CARD
200e EDGE TERMINAL

What is claimed is:

1-26. (canceled)

27. A utilization control terminal comprising:
at least one storage device configured to store instructions; and
at least one processor configured to execute the instructions to:
acquire, from a storage medium that is carried by a predetermined user and stores attribute information and first biometric information of the user, the attribute information and the first biometric information by a predetermined mode of short-range radio communication;
save the attribute information and the first biometric information in a storing apparatus in such a way that they are associated with each other;
perform biometric authentication based on second biometric information extracted from a captured image of the user and the first biometric information saved in the storing apparatus;
specify attribute information associated with the first biometric information that has succeeded in the biometric authentication; and
output a usage fee of a predetermined service calculated based on the attribute information.

28. The utilization control terminal according to claim 27, wherein the at least one processor is further configured to execute the instructions to:
output the usage fee calculated taking into account a discount based on the attribute information.

29. The utilization control terminal according to claim 27, wherein the at least one processor is further configured to execute the instructions to:
output, when the attribute information indicates an elderly person, a person with disabilities, or a student, the usage fee calculated taking into account a discount in accordance with each attribute information.

30. The utilization control terminal according to claim 27, wherein the at least one processor is further configured to execute the instructions to:
output the usage fee calculated taking into account a discount in accordance with a date of birth in the attribute information.

31. The utilization control terminal according to claim 28, wherein the at least one processor is further configured to execute the instructions to:
output, when it has accepted an electronic application for using a predetermined service, the usage fee calculated taking into account a discount based on the attribute information.

32. The utilization control terminal according to claim 27, wherein the at least one processor is further configured to execute the instructions to:
output, when it is determined that the user can be permitted to use the service based on the result of the biometric authentication, an entry permission notification to an entry control apparatus that controls entry of the user.

33. The utilization control terminal according to claim 27, wherein the at least one processor is further configured to execute the instructions to:
output, when it is determined that the user can be permitted to use the service based on the result of the biometric authentication, display information indicating that the user can be permitted to use the service.

34. The utilization control terminal according to claim 27, wherein the at least one processor is further configured to execute the instructions to:
output, when the biometric authentication has failed, guidance information of a mode of the short-range radio communication to be used to acquire the attribute information and the first biometric information.

35. The utilization control terminal according to claim 27, wherein
the storage medium is a non-contact type Integrated Circuit (IC) card capable of performing short-range radio communication by a predetermined mode, and
the at least one processor is further configured to execute the instructions to:
acquire the attribute information and the first biometric information by short-range radio communication with the non-contact type IC card by the predetermined mode.

36. The utilization control terminal according to claim 27, wherein the utilization control terminal is a mobile terminal.

37. A utilization control method causing a computer to:
acquire, from a storage medium that is carried by a predetermined user and stores attribute information and first biometric information of the user, the attribute information and the first biometric information by a predetermined mode of short-range radio communication;
saving the attribute information and the first biometric information in a storing apparatus in such a way that they are associated with each other;
performing biometric authentication based on second biometric information extracted from a captured image of the user and the first biometric information saved in the storing apparatus;
specifying attribute information associated with the first biometric information that has succeeded in the biometric authentication; and
outputting a usage fee of a predetermined service calculated based on the attribute information.

38. A non-transitory computer readable medium storing a utilization control program for causing a computer to execute:
acquiring processing for acquiring, from a storage medium that is carried by a predetermined user and stores attribute information and first biometric information of the user, the attribute information and the first biometric information by a predetermined mode of short-range radio communication;
saving processing for saving the attribute information and the first biometric information in a storing apparatus in such a way that they are associated with each other;
authentication processing for performing biometric authentication based on second biometric information extracted from a captured image of the user and the first biometric information saved in the storing apparatus;
specifying processing for specifying attribute information associated with the first biometric information that has succeeded in the biometric authentication; and
output processing for outputting a usage fee of a predetermined service calculated based on the attribute information.
